(19) United States
(12) Patent Application Publication
(10) Pub. No.: US 2007/0260583 A1
(43) Pub. Date: Nov. 8, 2007

(54) Method for fast substructure searching in non-enumerated chemical libraries

(75) Inventors: Daniel Domine, Beaumont (FR); Cedric Merlot, Collonges-sous-Saleve (FR)

Correspondence Address: SALIWANCHIK LLOYD & SALIWANCHIK;A PROFESSIONAL ASSOCIATION, PO BOX 142950, GAINESVILLE, FL, 32614-2950, US

(73) Assignee: APPLIED RESEARCH SYSTEMS ARS HOLDING N.V., CURACAO (AN)

(21) Appl. No.: 10/591,091

(22) PCT Filed: Mar. 1, 2005
(86) PCT No.: PCT/EP05/50891

§ 371 Date: Aug. 29, 2006

(30) Foreign Application Priority Data
Mar. 5, 2004 (EP) 04100906.9

(51) Int. Cl. G06F 17/30

(52) U.S. Cl. 707/3

(57) ABSTRACT

The present invention relates generally to searching substructures in virtual combinatorial libraries. More precisely, it describes a method of operating a computer for searching substructures in large, non-enumerated virtual combinatorial libraries. Advantageously, the method can return matching products as non-enumerated substructures.

### FIELD OF THE INVENTION

The present invention relates to a method of operating a computer for the search of all the product structures (exact hits) implicitly defined by one or more Markush structures in large, non-enumerated virtual combinatorial libraries (VCL), in a time-limited manner.

### BACKGROUND OF THE INVENTION

Recent advances in combinatorial chemistry and high throughput screening have made it possible to synthesise and subsequently test in biological assays large numbers of compounds. Compared to standard, one-at-a-time chemical reactions that require several days of work for a chemist to produce a single compound, combinatorial chemistry enables synthesis of several thousands of compounds in a short time.

Results brought by combinatorial chemistry for bioactive compound discovery have nevertheless been disappointing. Whereas many more compounds are synthesised, hit-rate remains very low, sometimes even lower than that achieved by conventional chemistry. One reason is that whatever the progress in combinatorial chemistry, the number of compounds that is actually synthesised will always remain very small compared to the myriad of structures one can imagine and cannot compensate for inadequately selected sets of compounds to tests. The challenge therefore consists in identifying which libraries should be synthesized without actually building them.

A solution consists in building in silico collections of structures for which synthetic scheme is known (1) and applying in silico screening techniques. Such collections are named virtual combinatorial libraries (VCL). The in silico screening paradigm (also named virtual screening) aims at applying computational methods to select the most appropriate compounds to synthesize and test in biological assays from virtual libraries. Among these computational methods, searching for privileged substructures has been shown to be efficient in the selection of libraries (2). There exist several tools for substructures searching. Some are based on functionalities found in commercial software, while others have been developed specifically for VCL. Tools for searching in patents have also been reviewed in this background section because they share many functionalities with those used for searching in VCL. All these tools are of interest for virtual screening, provided they are suitably fast and relevant to process large amount of combinatorial compounds (I).

Searching in Specific Structures

### SUMMARY

Specific structures have their representation stored in a database as a single element, in opposition to generic structures that implicitly describe more than one structure in a single database element. Generic structures are also often termed Markush structures, since Markush has claimed in a patent a set of structures implicitly described by a generic structure in the 1920's.

Mechanised specific atom-by-atom structure matching of a query and stored structural representations is a well-known commercial technique that has been available since the 1960's and has demonstrated high recall and precision as a search and retrieval technique. Many improvements, such as structural keys, have also been implemented. They have made these algorithms very efficient for daily needs, such as searching in corporate databases. However, VCL are not comparable to corporate databases, in that they can contain many more compounds. This implies that applying algorithms used for searching corporate databases to VCL is not straightforward and sometimes not even practically feasible.

Searching with Graph Matching Algorithms

Based on graph theory, algorithms exist that can determine whether the graph associated to a query structure is a sub-graph found in the graph associated to a structure stored in the database.

Several publications describe different techniques to search in database of specific structures (3, 4, 5, 6, 7).

Because atom-by-atom structure matching is a relatively slow process, screening techniques have been developed to eliminate high percentage of irrelevant stored representations.

Searching by Structural Keys

Structural keys (6, 8) are one of those techniques, which have been largely developed. Keys consist in structural features such as atom environment and atom sequences. They are extracted only once from the stored structures, and then stored in their turn as single database element. When a query is submitted, the same set of keys is also extracted from it. The technique relies on the fact that stored structures that could match the query must contain keys found in said query. Based on this, keys are used as filters to quickly reject stored structures that cannot match the query. The few remaining stored structures are then investigated using more time-consuming but exact graph matching algorithms.

Limits of Searching Enumerated Libraries

Implementing a VCL search engine would be straightforward if total enumeration of the library was feasible. But it has been shown that a single diamine library may easily contain 10¹² structures (1). If 100 bytes are needed to store each product structure, the disk requirements for an enumerated library would be of the order of 10 terabytes, and the library creation time at a rate of 10,000 structures per second would be −3 years (1). In addition, 10¹² is relatively small in the VCL paradigm.

It is therefore not practical to expand libraries to a set of specific structures, since the number of specific structures derived from the enumeration of one generic structure easily explodes to billions.

As such, algorithms that allow searching in specific libraries are not applicable to VCL. This type of database will require specific algorithms able to work with non-enumerated structures, such as Markush structures.

Markush Searches in Specific Structures

A mean to avoid storage of numerous specific structures is to store them as Markush structures, since a single Markush structure can implicitly define billions of compounds found in a combinatorial library in a relatively small space. Besides this, all specialised software vendors propose methods for searching for a Markush structure into a database of specific structures (9). Thus, if there was a way to reverse this Markush search process, commercial software may be able to search for specific structures in non-enumerated libraries made of Markush representations. However, this is not feasible (10).

Substructure Search in Patents

### SUMMARY

The most efficient way to store VCL is achieved by the use of Markush representations. Historically, Markush representations have first been employed in patents, and much work has been done since the 60's to search in Markush structures. This resulted in a large amount of algorithms, giving more or less precise results. These algorithms can be classified into two categories: those that are based on fragmentation-codes and those that use a connection table. But none of those algorithms can be straightforwardly applied to searching VCL, because the concepts are too different.

Search Algorithms

The ability to effectively retrieve information on Markush structures has been a problem of varying magnitude and complexity since the creation of this type of representation. Many manual and mechanised information retrieval systems have been developed to meet the challenge of this problem (11, 12, 13, 14, 15, 16). These techniques aim at determining whether a specific structure is involved in any of the structures implicitly described by a Markush representation (10).

Fragmentation Codes

Most of the methods developed since the 1960s involved the use of system of fragmentation codes. These fragments are generic or real atom group representations of various chemically significant units, such as rings, chains and functional groups that are encoded manually or automatically before registration in a database. For example, chains containing only carbon atoms are usually replaced by the generic fragment code named “alkyl” (17, 18, 19, 20, 21).

An example of this approach is described in (22). The authors disclose a search algorithm that assigns different attributes, such as ring size, nature of the atoms in a cycle, and number of atoms in an alkyl group to generic structure units, in stored structures as well as in the query. This approach allows comparison of generic groups C1-C5 and C4-C7, whose common subset consists in the chains made of four or five atoms. However, this method is unable to take in account the isomers of position. For example, in a group named “5-membered cycle containing an oxygen”, the description does not give the exact position of the oxygen. Another shortcoming with this approach is that one has to know the coding rules and use the codes explicitly, for instance PROPYL and C3 ALKYL. This also poses the problem of the undefined connectivity between the chemical groups, even if some workarounds have been proposed (23). All these issues avoid the possibility of searching exactly for a structure, or a substructure, like one would do in a database made of specific structures.

Besides this approach, the MARPAT system from Chemical Abstract Service and the Markush DARC system from Derwent Information Ltd., Questel SA, and the French Patent Office (INPI) both use a set of super-atoms to represent generic groups such as alkyl, or aromatic carbocyclic group (24, 25). Search process is performed by a screening phase based on limited-environment fragments (keys), followed by an atom-by-atom search on structures that have passed the first phase. In Markush DARC, it was not possible in 1991 to match an alkyl group against an n-butyl substructure (24): superatoms cannot be matched against real atoms. MARPAT avoids this limitation, since it can convert groups, but is error-prone. In the above example, the n-butyl would first be converted into an “alkyl” superatom, which could result in wrong matches. For instance, an n-butyl converted into an “alkyl” superatom would be found to match a t-butyl, which is not the case in exact substructure search.

GENSAL/GREMAS, from IDC, is a fragmentation code-based system (24) using GREMAS codes and reduced chemical graphs (26, 27, 28) that have been developed at the Sheffield University (11, 12, 13, 14, 15, 16, 29, 30, 31, 32, 33).

Other methods (34) propose a filtering step, in which a large amount of structures is eliminated before an atom-by-atom or group-by-group comparison of the query against stored structures. This approach is an application of screening techniques already described for specific structures. First, Markush structures are re-written using a specific multiple connectivity node representation (SnMCN), then using the corresponding generic multiple connectivity node representation (GnMCN), representing all the individual generic structural representations (IGSRs) of said Markush representation. IGSRs of the query are then compared to IGSRs of stored structures. Matching representations are then compared atom-by-atom or group-by-group. This method still presents some shortcomings, as during the transformation into IGSR, many structures initially not present in the Markush representations are included.

Yet another example of screening is described in patent EP451049. This patent discloses a method in which the “search by keys” technique used in specific structure search algorithms is applied to screening generic structures found in patents. This technique has also been used in other algorithms (35, 36). After filtering, a refined search method has to be applied, such as in (27). This method is described later in this background section.

Even if some systems are said to give good results, no viable system for searching Markush structures involving fragmentation codes that gives a high degree of recall and precision has yet been achieved (3). Known techniques for such retrieval are imprecise and often place a premium on the knowledge, intuition, and cognitive skills of the searcher. Also, the inter-relationships among these groups in a Markush structure are not precisely encoded and many answers are irrelevant to the query (11, 12, 13, 14, 23, 37).

Connection tables

Introduction of connection tables has largely improved searching capabilities compared to fragment-description based methods (38). The use of connection tables for substructure searching ensures both good recall and precision due to the unique nature of the representation. E. Meyer at BASF has developed in 1958 a search algorithm based on connection-tables (39). His approach has been the basis for a lot of other methods, even if the initial implementation developed in 1950 contained some limitations (nine alternatives for each of three R-groups) (40). In the connection table approach, Markush structures consist in a scaffold containing one or more R-groups. The scaffold is made of a list of atoms, their connectivity, and also the position of the R-groups. Each R-group consists in a list of substituents that will replace it in the scaffold. Each R-group member is made of a list of atoms, their connectivity, and a list of attachment points.

This approach allows searching for substructures that span over the scaffold and one or several R-groups. During an atom-by-atom search, if the first atom of the query is found in an R-group member, the algorithm will follow the path within that member. Once the path arrives on the atom that is the attachment point, the search is automatically continued in the scaffold, at the position next to the R-group. When the first atom is in the scaffold, once the path arrives on an R-group, each member of the R-group is scanned to find the remaining atoms of the query, until a match is found.

This approach is well suited for patent searches, which aim at determining whether a query can match at least one of the structures implicitly defined by the Markush structure. Once the first match is found the method returns a success code, with no computational effort done to found other hits. In the VCL context, the problem is to retrieve all the hits. In this paradigm, E. Meyer algorithm's performance can easily be reduced to something comparable to searching in enumerated libraries, especially when the query spans across the scaffold and two or more R-groups. Indeed, let's assume that the first atom of the query is found in R-group 1, and that the query is not entirely contained in that R-group. In this case, the search has to be continued in the scaffold. If we also assume that the remaining part of the query cannot be found entirely in the scaffold, but can be continued in R-group 2, all the members of R-group 1 that match the beginning of the query have to be searched to detect all the matches. For each matching member of R-group 1, the query will have to follow on the scaffold until it reaches R-group 2, and then be searched in each member of R-group 2. In practice, it means that for each match in R-group 1, all the structures made of that member and one member in R-group 2 will have to be enumerated. In the worst case, this increases the computational time to something comparable to enumerating all the structures in the library.

Another method described in (27) is based on connection tables. The graph associated to the query and stored structures is transformed into a reduced graph. In this paper, a reduced graph of a structure is a graph in which nodes represent chemically significant groups, and the links between these groups are represented by edges. Nodes are then assigned some properties depending on the corresponding chemical group, such as cyclic node, or acyclic, all-carbon nodes. Reduced graphs of query and stored structures are mapped, in a filtering step, so that nodes in the query and in stored structures can match only when they have common attributes. Results after that filter consist in several lists of pairs of corresponding reduced nodes, which correspond to the many different ways to map the query on stored structures. These lists are called maps because they represent a “matching path” through the two reduced graphs. They are then sent to a refined atom-by-atom matching algorithm which checks whether the query is actually found in the stored structures, including verification of position isomers. The refined search involves the development of an algorithm in which the standard 1:1 mapping between atoms of the two structures has been relaxed to a 1:N (then by extension N-N) relation. This means that a generic group in the structure can map against more than one real atom in the query. When all the pairs of reduced nodes involved in a map match at the atom-by-atom comparison level, the stored structure is said to be a hit.

This method is an extension of the fragment-based approaches, for which most of the deficiencies encountered are corrected. It suits well to Markush structures, as they are stored in patents because, in this context, nodes of the reduced graph and R-groups refer both to chemically significant units, such as heterocycles, or carbon chains. In VCL, R-groups do not necessarily refer to such units, and most of the time members of R-groups contain several units, which differ from one member to the other. This means that VCL R-groups cannot be summarised straightforwardly by one or several chemically significant units, as it is assumed in the algorithm.

Markush Structures in Patents

Even if the same name is used, Markush structures in patents and in VCL do not have the same meaning and search algorithms do not have to give same types of results in both paradigms (41, 42).

To widen the coverage of the claims, the description of those structures is as generic as possible, allowing for example a variable group to be any alkyl chain (possibly of limited size) or heterocycle. Such generic units can then belong to a list of chemical families (homology variation, see 42), families that can contain an unlimited number of members. Of course, the generic unit could also consist in a limited list of substructures. Thus, a single Markush structure often covers implicitly thousands of millions of specific chemical structures, if not an unlimited number of compounds. The algorithms for searching Markush structures in patents must be adapted to that way of describing chemical structures.

Unlike Markush structures found in patents, Markush structures in VCL implicitly contain a limited number of compounds, because each variable group (R-group) is defined as a finite list of substructures (e.g.: —Me, -Et, -iPr), and not as a family of structures like in patents. Thus, it is theoretically possible to enumerate all the specific structures described by the library.

Moreover, while searching for a substructure in a patent, one wants to test whether the structure can be found in that patent (10). In other words, the test consists only in finding at least one structure implicitly described in the Markush structure that matches the query. Once that structure has been found, the Markush structure in a whole is said to be a hit, and the following structure in the database is investigated. In the VCL paradigm the approach is quite different, since it aims at retrieving all the specific structures in the VCL matching the query, and not only the Markush representation that may also contain implicit structures that may not match the query.

Substructure Search in Non-Enumerated Combinatorial Libraries

### SUMMARY

Several approaches have been proposed to search, Markush structures. Most of them are not adapted to the VCL paradigm because they miss some results, or do not return what can be expected (partial search like in patents). Other methods have been designed to recall all hits, but they become time-consuming with large VCL.

Incomplete Searches

Daylight, through its Monomer Toolkit, provides a range of software routine for the manipulation of combinatorial libraries stored using CHUCKLES and CHORTLES notations, including searching using a query language called CHARTS (40). This algorithm allows searching “without enumeration” of the library, but as in fragment based search algorithms in patents, the query and the stored structure must use the same definitions. When the query and the stored structure do not use the same definitions (e.g. when the query is a structure and stored structures are made of monomers), matches that involve a substructure spanned across several monomers will not be found unless a full enumeration is done. In other words, an exact atom-by-atom match can only be obtained by enumerating all the structures contained in the generic structure (40, 43).

RS3 (Accelrys Inc., San Diego, Calif. 92121-3752, USA, http://www.accelrys.com) is able to store and search in nonenumerated structures. But it is unable to enumerate all the structures that are recognised as hits. When a hit is found in the Markush structure, it is the generic structure that is returned as a hit, as it is done in patents.

Searching VCL

Chem-X (44) uses a special keyed 2D-search to filter the database, an equivalent of keyed search filter used for specific structures. Structures that pass this filter are then enumerated and searched using atom-by-atom match (45). Chem-X also proposes several tools to perform 3D-based searches, but they are beyond the scope of the present invention.

MDL Central Library (MDL Information Systems, Inc., San Leandro, Calif. 94577, http://www.mdl.com) stores a library using a Markush representation. It also allows one to retrieve hits that match the query. The search process implies explicit enumeration of all the compounds described by the Markush representation and is of no help for the management of large combinatorial libraries.

In patent WO 01/61575 and (46), Lobanov et a describe a substructure search algorithm. They have designed their method so that searching in large, non-enumerated libraries is feasible in a reasonable amount of time. This method is based on sampling. At the beginning of a new search, only a small part of the library is enumerated The query is then searched in that partially enumerated library. Based on the results, the method predicts which reagents will be involved in the products that match the query. Once the reagents are known, the method can easily give the matching products. This method gives good results, but it is still time-consuming. As an example, the inventors claim that a similarity search in a library made of 6.75 millions structures takes 30 minutes on a dual processor 400 Mhz Intel Pentium II machine. Moreover, it is far from being exact because of the statistical approach employed. It therefore fails to return 100% hits.

Tripos also proposes its own language called cSLN. This language is used in different software such as LEGION, which is used to generate the cSLN from a graphical input, SELECTOR that is able to perform similarity searches (40), and UNITY that allows searching in the cSLN. The algorithm, based on similarity search, uses validated molecular descriptors and 2D fingerprints (U.S. Pat. No. 6,240,374, US20020099526 and U.S. Pat. No. 6,185,506).

Finally, Barnard et al have presented a search algorithm (47) based on reduced graphs already mentioned in patent searches (26, 27, and see description of reduced graphs before). When R-groups contain members made of different chemically significant units, the different reduced graphs that result from the association of different R-group members onto the scaffold are modified in order to obtain a single reduced graph per library. However this transformation can only be achieved at the price of having few chemically significant units, and/or multiplying allowed units at a given position, which reduces the filtering power of reduced graphs This means that many structures will enter the refined search step, which is the most time-consuming, and may even require enumeration of stored structures. It also seems not obvious how such an algorithm may map a chain over a part of a ring, which are two opposed chemical units.

Storage of Virtual Libraries

Most of the systems to search for Markush structures in patents do not need to store the Markush representation in something other than in flat files.

A few systems describe a way to store VCL in a way that allows high definition of the libraries and of the reactions involved in the library creation (48, 49). Nevertheless those systems do not propose a method for searching a given substructure except by enumerating all the compounds in the database.

Works on Non-Enumerated Libraries

### SUMMARY

Several algorithms allow different kind of calculations on non-enumerated VCL (1), including similarity searching or clustering, that enable compound selection. Others propose to search for a pharmacophore in non-enumerated VCL. No 2D substructure search algorithm seems therefore to have been developed so far for virtual combinatorial libraries.

Descriptors in Non-Enumerated VCL

Barnard et al have developed several tools to perform calculations in non-enumerated VCL. Examples include a generator of structural descriptors (50, 51, 42, 52). These descriptors can then be used in similarity searches and clustering (53). Unlike substructure search, similarity search relies on the comparison of a list of small fragments found in the query and stored structures. Thus, a structure in the library can be found similar to the query even if the query is not totally contained in that structure: similarity and exact substructure search do not have the same goal.

The C² Diversity (54) system also proposes an R-group based diversity method, by looking at diversity in the R-groups (42). Nevertheless, this approach of diversity may not be justified (55).

Several filtering methods that allow selection of compounds to be synthesized from a virtual library have also been proposed (56). These filters are based on the prediction of product properties such as molecular weight, logP, van der Waals volumes, solvent accessible surface areas. These properties are first calculated for the reagents, and then the algorithms assume that these properties are additive to derive the property for the product.

3D VCL

In U.S. Pat. No. 6,343,257 and (57), Olender et al have described an algorithm for searching for a pharmacophore in large 3D virtual libraries.

A computer program from Tripos (Tripos Inc., St Louis, Mo. 63144-2319, USA, http://www.tripos.com), called ChemSpace, performs searches without enumeration of the libraries. However, only 3D searches are concerned (58).

Several algorithms do exist that try to tackle the problem of substructure search in non-enumerated VCL. However, all the above algorithms have inherent limitations that prevent them to deliver complete, exact and time-limited hits, being either time-consuming, or resulting in either incomplete or wrong answers (statistical approach) in large combinatorial searches.

The new algorithm described in the present invention solves the problem of searching and retrieving all exact hits in large combinatorial libraries from a substructure search in large VCL in a time-limited manner (as enumeration is not required).

### SUMMARY OF THE INVENTION

The present invention relates to the development of a new algorithm called NESSea for Non-Enumerative Substructure Search. NESSea allows the retrieval of all exact hits from a substructure or structure search in large VCL in a time-limited manner. The invention is characterized by a search, which does not require enumeration of structures (generation of product structures not necessary).

Therefore, in a first aspect of the invention, it provides a method of operating a computer for accomplishing the identification of all the product structures implicitly defined by at least one Markush structure (200, 220, 260), which is (are) stored in at least one database matching at least one given query structure (200), without the necessity of generating the product structures, comprising the steps of:
(i) Processing the Markush structure(s) and the query(ies) into a computer readable form (210),
(ii) Searching for partially relaxed subgraph isomorphism(s) for each query (230, 240, 250),
(iii) Retrieving data (270).

In a second aspect of the invention, it provides a computer program for accomplishing the automatic identification of all the product structures defined by one or more Markush structure(s), which is(are) stored in one or more database(s) matching one or more given query structure(s), without the necessity of generating the product structures, comprising computer code means adapted to perform all steps according to the first aspect of the invention when the program is run on a computer.

In a third aspect of the invention, it provides a computer readable medium having a program recorded thereon, where the program is to make the computer to carry out the method according to the first aspect of the invention.

In a fourth aspect of the invention, it provides a computer program product stored on a computer usable medium, comprising a computer readable program means for causing the computer to identify all the product structures defined by one or more Markush structure(s), which is(are) stored in one or more database(s) matching one or more given query structure(s), without the necessity of generating the product structures according to the first aspect of the invention.

In a fifth aspect of the invention, it provides a computer loadable product directly loadable into the internal memory of a digital computer, comprising software code portions for performing the steps of the first aspect of the invention when the product is run on a computer.

In a sixth aspect of the invention, it provides an apparatus for carrying out the method of the first aspect of the invention including data input means for inserting at least one given query structure characterized in that there are provided means for carrying out the steps of the first aspect of the invention.

In a seventh aspect of the invention, it provides a computer program according to the second aspect of the invention embodied on a computer readable medium.

In an eighth aspect of the invention, it provides a means to identify bioactive compounds by performing the method according to the first aspect of the invention.

### DESCRIPTION OF THE FIGURES AND ANNEXES

FIG. 1: The Markush representation.

FIG. 2: Flowchart illustrating the main method of the present invention in a preferred embodiment of the invention. N=NO, Y=YES.

FIG. 3: Flowchart illustrating the steps performed in partially relaxed subgraph isomorphism searching, according to a preferred embodiment of the present invention. N=NO, Y=YES. Procedures A, B and C are described in FIGS. 4, 5 and 6, respectively.

FIG. 4: Flowchart illustrating the steps performed in subroutine A (370) of FIG. 3 corresponding to the case where the query is located only on the scaffold, according to a preferred embodiment of the present invention. N=NO, Y=YES.

FIG. 5: Flowchart illustrating the steps performed in subroutine B, (380) of FIG. 3 corresponding to the case where the query is located only on a single R-group, according to a preferred embodiment of the present invention. N=NO. Y=YES.

FIG. 6: Flowchart illustrating the steps performed in subroutine C (360) of FIG. 3 corresponding to the case where the query spans across the scaffold and one or more R-groups, according to a preferred embodiment of the present invention. N=NO, Y=YES.

FIG. 7: Flowchart illustrating the steps performed in the test “Does R-group member contain query or subquery?”, according to a preferred embodiment of the present invention. The test is used in both subroutines B and C of respectively FIGS. 5 (510) and 6 (640). If the test returns true (the member does contain the query or the subquery), then NESsea continues to 520 or 650, corresponding to “flagging Rgroup member”. If the test returns false (the member doesn't contain the query or the subquery), then NESsea continues to 530 or 660, corresponding to the test “more Rgroup members?”. The test also checks for the presence of nested R-groups. N=NO, Y=YES.

FIG. 8: Example of substructure search in large VCL.

FIG. 9: Examples of query structures handled by the method.

FIG. 10: Example of query structure localization.

FIG. 11: Representation of sub-libraries (Table 7) as an array. The first sub-library is drawn with vertical lines and the second one with horizontal lines. The overlap is hashed (Table 8).

FIG. 12: Illustration of the exact localizations of a query structure in different enumerated structures, which allow for the counting of occurrences of the query structure in the compounds for a given isomorphism.

FIG. 13: Representation of sub-libraries (Table 9) as an array. The first sub-library is drawn with vertical lines and the second one with horizontal lines. The overlap is hashed (Table 10).

FIG. 14: Screenshot of a given query structure.

FIG. 15: Screenshot of the current status of the job processed.

FIG. 16: Screenshot of the results or hits from the query of FIG. 14 identified by the section “Mappings”.

FIG. 17: Screenshot of possible options allowed before the enumeration of a particular sub-library.

FIG. 18: Screenshot of enumerated structures.

FIG. 19: Screenshot of the partial localization of the query structure of FIG. 14 on a particular R-group member.

Annex 1: The custom made code for processing a library's scaffold and R-groups as well as for searching in non-enumerated Markush structures.

### DETAILED DESCRIPTION OF THE INVENTION

The present invention relates to an algorithm called NESSea for Non-Enumerative Substructure Search. NESSea is an automated method for structure(s) or substructure(s) search in non-enumerated Virtual Combinatorial Library(ies) (V(CL). More particularly, the present invention is based on the development of a new algorithm allowing the retrieval of all exact hits from a substructure or structure search in large VCL in a time-limited manner. The present invention is characterized by a search that does not require enumeration of structures (generation of product structures not necessary).

The following paragraphs provide definitions of various terms, and are intended to apply uniformly throughout the specification and claims unless an otherwise expressly set out definition provides a different definition.

Graph

The terms “molecular graph” or “graph” refer to the representation of a molecule in relationship with graph theory. It consists in a set of nodes representing the atoms of the molecules, and in a set of edges representing bonds between atoms. Labels are assigned to nodes to represent atom types (carbon, oxygen . . . ) and to edges to represent bond types (single bond, double bond, triple bond . . . ).

Neighbour in Graph

Two nodes in a graph are termed “neighbours” if there exists one edge joining the two nodes.

Subgraph

A “subgraph” Gs is a graph made of a subset of nodes and edges of a parent graph Gp.

Binary Description

The term “binary description” of a molecule is a representation that a computer can use (i.e. a computer readable form or representation).

Subgraph Isomorphism

A “subgraph isomorphism” exists if all the nodes (atoms) of one query graph (Gq) can be mapped to a subset of the nodes of a target graph (Gf) in such a way that the edges (bonds) of Gq simultaneously map to a subset of the edges in Gf. In other words, if two nodes in Gq are joined by an edge then they can be mapped onto two nodes in Gf if and only if the two nodes in Gf are also joined by an edge. Furthermore, the labels carried by the nodes and edges must be identical if the nodes or edges are rapped to each other. (see Substructure Searching Methods: Old and New, Barnard, J M, J. Chem. Inf. Comput. Sci. 1993, 33, 532-538).

Graph Isomorphism

The term “graph isomorphism” refers to a special case of subgraph isomorphism, wherein all the nodes and all the edges in the graph Gf are mapped to graph Gq. In other words, the two graphs are identical.

Partially Relaxed Isomorphism

In subgraph isomorphism, nodes in graph Gf are mapped to at most one node in the query graph Gq. The terms “partially relaxed subgraph isomorphism” or “partially relaxed isomorphism”, which are used interchangeably, allow one-to-many relationships (see figure below). This means that an atom in the target structure (Gf) can be used to represent a generic group on which several (N) atoms in the query (Gq) can be mapped (hence the term 1 to N mapping) (see Holliday and Lynch, J. Chem. Inf. Comput. Sci, 1995, 35 659-662). 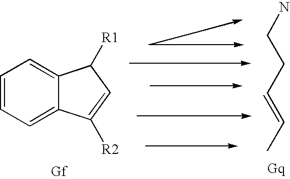
Substructure Searching, Query, Product Structure

Stated at its simplest level, the term “substructure searching” refers to the process of identifying those members of a set of full structures (in the present invention full structures are also termed “product structures” or “chemical structures” and can be used interchangeably), which contain a specified query structure. In graph-theoretical terms, it involves testing a series of topological graphs for the existence of a sub-graph isomorphism with a specified query graph (see Substructure Searching Methods: Old and New, Barnard, J M, J. Chem. Inf. Comput. Sci. 1993, 33, 532-538).

Markush Structure, Scaffold, Rgroup, Rgroup label, Rgroup Member, Attachment Point

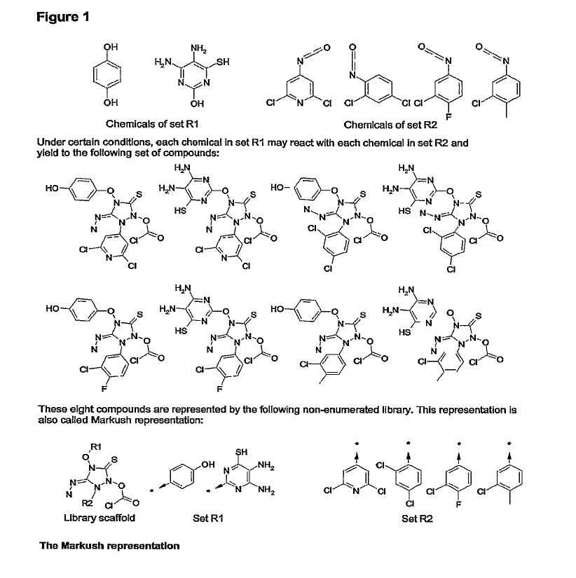

The term “Markush structure” (or “Markush representation” or “Markush type formula”, which can be used interchangeably) is a compact representation of a set of specific molecules with common structural features, such as in combinatorial libraries. An example is shown in FIG. 1. A Markush structure consists in a scaffold and one or several Rgroups. The term “scaffold” refers to the chemical moiety common to all compounds in the set. It also contains variable groups termed “Rgroups”, which are usually labelled R1, R2 . . . . Each Rgroup has an arbitrary number of explicitly defined members, with explicitly defined attachment points (see FIG. 1). Rgroups may be “nested” arbitrarily. In other words, an Rgroup member can itself contain other Rgroups. This representation may be contrasted with that developed by the Sheffield group for representing the more general case of generic structures found in patents. In their representation, variable positions of attachment points are accommodated in a single scaffold, and Rgroup member lists can contain “generic” substituents such as aryl or cycloalkyl.

The definitions of “virtual library”, “virtual combinatorial library” and “enumeration” are taken from patent application WO01/61575, and have been fully included hereafter.

Virtual Library

The term “virtual library” refers essentially to a computer representation of a collection of chemical compounds obtained through actual and/or virtual synthesis, acquisition, or retrieval. By representing chemicals in this manner, one can apply cost-effective computational techniques to identify compounds with desired physico-chemical properties, or compounds that are diverse, or similar to a given query structure. By trimming the number of compounds being considered for physical synthesis and biological evaluation, computational screening can result in significant savings in both time and resources, and is now routinely employed in many pharmaceutical companies for lead discovery and optimization.

Virtual Combinatorial Library (YCL)

Whereas a compound library generally refers to any collection of actual and/or virtual compounds assembled for a particular purpose (for example a chemical inventory or a natural product collection), the term “virtual combinatorial library” represents a collection of compounds derived from the systematic application of a synthetic principle on a prescribed set of building blocks (i.e., reagents). These building blocks are grouped into lists of reagents that react in a similar fashion (e.g. A reagents and B reagents) to produce the final products constituting the library (C, Aᵢ+Bᵢ® Cᵢⱼ). Full virtual combinatorial libraries encompass the products of every possible combination of the prescribed reagents, whereas sparse combinatorial libraries (also called sparse arrays) include systematic subsets of products derived by combining each Aᵢ with a different subset of Bᵢ's. Unless mentioned otherwise, the term virtual combinatorial library will hereafter imply a full virtual combinatorial library.

A virtual combinatorial library can be thought of as a matrix with reagents along each axis of the matrix. For example, the chemical reaction Aᵢ+Bₗ®Cᵢⱼ, may be represented by a two dimensional matrix with the A reagents along one axis and the B reagent along another axis. If there exist 10 different A reagents and 10 different B reagents, then a virtual combinatorial library representing this chemical reaction would be a 10×10 matrix, with 100 possible products (also referred to as possible compounds or reagent combinations). If the chemical reaction to be represented by a virtual library were Aᵢ+Bᵢ+Cₖ®Dᵢⱼₖ, and reagent class A included 1,000 reagents, reagent class E included 10,000 reagents, and reagent class C included 500 reagents, then a virtual combinatorial library representing this chemical reaction would be a 1,000×10,000×500 matrix (i.e., a three dimensional matrix), with 5×10⁹ possible products (i.e., Dᵢⱼₖs). The possible products that are represented by cells of the virtual combinatorial library matrix need not be explicitly represented. That is, the possible products in each cell of the matrix need not be enumerated. Rather, the possible products in each cell can simply be thought of as Cartesian coordinates corresponding to a particular reagent combination, such as A₁B₅. Unless mentioned otherwise, a virtual combinatorial library should be thought of as a matrix representing a chemical reaction where the products have not been enumerated. Explained another way, a virtual combinatorial library can be thought of as a matrix having a defined size but with empty cells. Each empty cell can be labeled as a reagent combination (e.g., A₁B₅). In contrast, a fully enumerated virtual combinatorial library can be thought of as a matrix having an enumerated compound in M each cell. Unless specifically referred to as an enumerated virtual combinatorial library, mention of a virtual combinatorial library refers to a non-enumerated virtual combinatorial library.

Enumeration

The term “enumeration” refers to the process of constructing computer representations of a structure of one or more products associated with a virtual combinatorial library. Enumeration is accomplished by starting with reagents and performing chemical transformations, such as making bonds and removing one or more atoms, to construct explicit product structures. In the general sense, enumeration of an entire virtual combinatorial library means explicitly generating representations of product structures for every possible product of the virtual combinatorial library.

VCL Description

A VCL is hence a collection of product structures resulting from reactions involving automated parallel synthesis. Synthesis of one product structure can be made in one or several steps. Several approaches are used to describe implicitly the structures (non-enumerated). There are for example reaction-based description and Markush representation. In the present invention, the Markush representation is preferred.

Markush representations allow a precise and concise definition of all the compounds in a library by giving a scaffold and one or several R-groups. The scaffold is either a reagent common to all the reactions schemes or the largest substructure common to all the product structures in the library. The scaffold can be viewed as a template made of atoms linked one to the other, some of which are super-atoms called R-groups. R-groups consist in a list of substructures (the “members”) that will replace corresponding super-atom in the product structure. Each R-group member is given an attachment point that determines the atom of that member that will be bound to the atom bound to the R-group in the scaffold. When the R-group is bound to several atoms in the scaffold, each member of that R-group must also contain the same number of attachment points. In that case, each neighbor of the R-groups in the scaffold is given an order, which correspond to the order of the attachment point.

R-groups members may also contain nested R-groups in their turn.

In the following example, the Markush representation describes implicitly nine structures.

| | R1 | R2 |
|---|---|---|
| 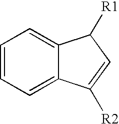 | 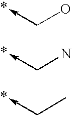 | 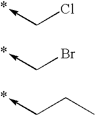 |
| 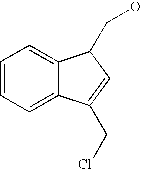 | 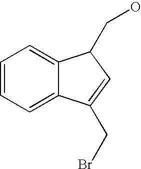 | 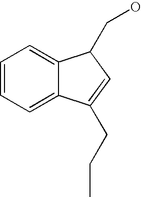 |
| 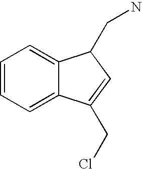 | 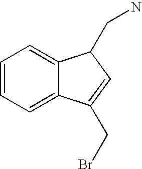 | 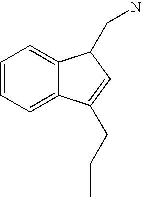 |
| 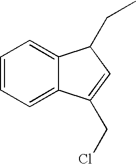 | 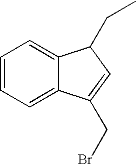 | 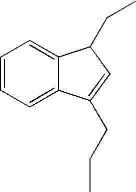 |

Markush representations are concise because the size required to describe a library grows as the sum of the number of members in each R-group (or reagents) involved. Instead full enumeration requires an amount of space that grows as fast as the product of the number of members in each R-groups. The library in the previous example consists in a scaffold and two R-groups, each containing three members. The number of structures necessary for the Markush representation is 1 (scaffold)+3 (first R-group)+3 (second R-group)=7 structures, whereas the size of corresponding enumerated library would be 3 (first R-group)×3 (second R-group)=9 structures. The improvement in this case is not obvious. However, R-groups in real VCL can easily contain 1,000 members. In these instances, the improvement becomes drastic, as the corresponding Markush representation will require 2,001 structures instead of 1,000,000 for the enumerated form.

There are cases in which the combination of one particular member of an R-group with few members of other R-groups is chemically impossible. Combinatorial chemistry tries to avoid this type of exception, or, alternatively, the library is split into different combinatorial libraries. When they are exceptional, these unviable structures are stored in a separate file that will be used to filter solutions once all the calculations in non-enumerated databases will be done.

Several VCL can be gathered in a database, so that searches will not be performed against only one but several VCL, in a single operation.

Search Algorithm

At the first stage of the algorithm, the user or a computer program submits one or more query(ies). Stored structures can match the query in different way:
The query is fully contained either in the scaffold or in some members of the R-groups. This type of search is already performed by algorithms that search in specific structures databases, and is also possible with the present invention.
The query spans across the scaffold and one or more R-groups. The process consists in finding all the different mappings between the query and the scaffold while postponing a detailed search in R-group members. This represents the present invention's object.
When R-group members contain nested Rgroups, the query may also span in a R-group. This case is only an extension of the previous one, in which the R-group member replaces the scaffold.

Sub-graph isomorphism algorithms are used to determine whether the graph associated to a query is embedded in the graph associated to a structure. In the case of a substructure search, the structure may be larger than the query, whereas in structure search both graphs must be identical, in which case the algorithm is termed graph isomorphism algorithm. One of the most popular graph and sub-graph isomorphism algorithm is the one described by Ullman.

In the present invention, all mappings of the graph associated to the query and the graph associated to the scaffold are searched using a sub-graph isomorphism algorithm. This algorithm has been relaxed to allow one-to-many (1:N) mappings (as mentioned in 27, for an other purpose). This means that several atoms in the query can be mapped to a single atom in the scaffold. The algorithm is partially relaxed in that it only allows R-groups in the scaffold to be mapped to several atoms in the query, while usual atoms are mapped one-to-one.

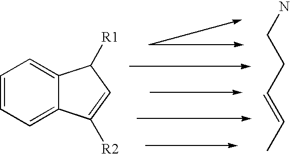

Ullman's algorithm has also been modified in order to be sure during the query-scaffold mapping step that atoms mapped to a given R-group make a connected graph. This check is optional at this point because it will be done implicitly in further steps but it reduces the number of mappings generated, hence reduces the time required for search. For example, the following mapping is not allowed because the graph on the right-hand side is not connected.

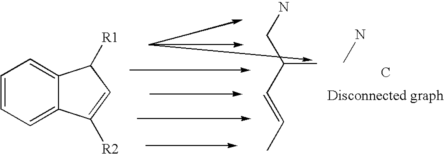

It has also been modified to improve its performance. This modification consists in a processing step prior to actual isomorphism detection, during which atoms in the query and in the structure are re-indexed. Re-indexation is done using a depth-first search method across the atoms, in which the index of the atom currently visited is set to the current number of atom visited as shown below.

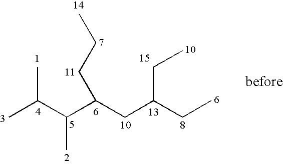

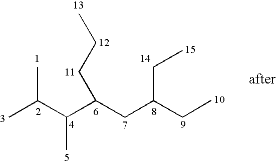

Ullman algorithm may also be relaxed to N:N correspondences to allow the query to be a Markush representation.

In a second step, for each query-scaffold mapping found, substructures made of the atoms in the query mapped to a same R-group are searched in each member of that R-group. Search step includes a graph-matching algorithm, in which a one-to-one (1:1) mapping is required. An additional condition must be satisfied for a successful mapping of the query against the product structure. Each neighbor of the R-group in the scaffold (Ca) involved in the query-scaffold mapping has a correspondence in the query (C₂), otherwise Ca would not be involved in the mapping. If a neighbor (C1) of the correspondence C2 is mapped to the R-group (R1), it must be mapped to the attachment point of the member of the R-group, corresponding to the order of the attachment involved in the bond Ca-R1 in the scaffold, in case R1 has several attachment points. The C2 correspondence always has a number of neighbors lower than the number of attachment points in the R-group R1. In the following example, atom C₁ must be mapped to atom Cb.

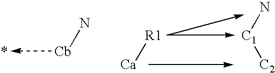

This search step can be adapted to support nested R-groups. The adaptation is done by reiterating step one several times, depending on nested R-groups, and also on the mapping involved. The example below represents a library of 10 structures, with nested groups. This means that one or several members of R1 contain an R-group. To search that kind of library, the first step will be the same: search all mappings using relaxed algorithm, then if R1 is involved in a mapping, the algorithm will go to step two. If R1 member does not contain R2 (first member) the algorithm will consist in step two described above. If R1 member does contain R2 (last three members), step one will be applied again, so as to find all mappings onto R1 of the substructure of the query mapped to R1. For each mapping, step 2 will be applied, and will do the same except that R1 will play the role of the scaffold and R2 will play the role of R1. This approach requires only a slight modification of the algorithm (testing whether the R-groups member contains an R-group).

| | R1 | R2 |
|---|---|---|
| 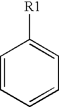 | 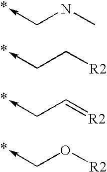 | 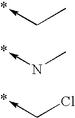 |

All the members of the R-group that match their part of the query are kept in a list of matching members for a given mapping.

Each R-group involved in scaffold-query mapping is investigated in that way. When an R-group is not involved in a mapping, all its members are said to match the query. When all R-groups have at least one member in their list of matching members, the query is said to be successful for that mapping, and the hits are all the structures implicitly described by the sub-library of matching members.

It is not rare in combinatorial chemistry to use a same list of members for different R-groups. This characteristic can be used in the search phase, whenever the same query is searched in different R-groups that have the same members. This will be particularly advantageous when the query is searched in a single R-group (i.e. for hits that do not span across the scaffold and R-groups). This could also happen in step two of the search, when the same substructure is searched in several R-groups that have the same members.

All the mappings are investigated in their turn, even if hits have been found in prior mappings. This method allows determination of all hits in the VCL.

Graphs are usually extracted from structures by replacing atoms by nodes and bonds by edges. This algorithm is still valid, even if it requires slight modifications, if nodes replace bonds and edges replace atoms.

The second step of this algorithm can be improved by using screening techniques such as those used for searching in specific structures. The preferred technique involves keys. Keys are sub-structural features, as is done for specific structures. But it also contains some information on the distance between the structural feature and the attachment point.

Results

Results are presented under different forms, either as a list of specific structures, or as a list of non-numerated sub-libraries made of the scaffold and the list of matching members. The former allows further processing using conventional tools on enumerated libraries (i.e. specific structures). The second allows further processing with specialized tools when the query returns a large number of hits.

The second also allows making the distinction between R-groups (i.e., reactions) that are or not involved in query matching. If an R-group is not involved in a query match, it means that even if that R-group was not present, the query would have matched to product structure. In some applications, this information warns the chemist that the reaction associated to the R-group may not be necessary.

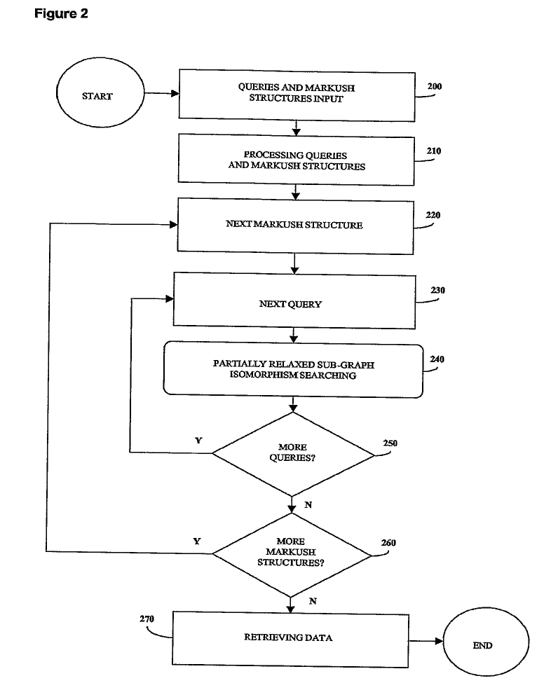

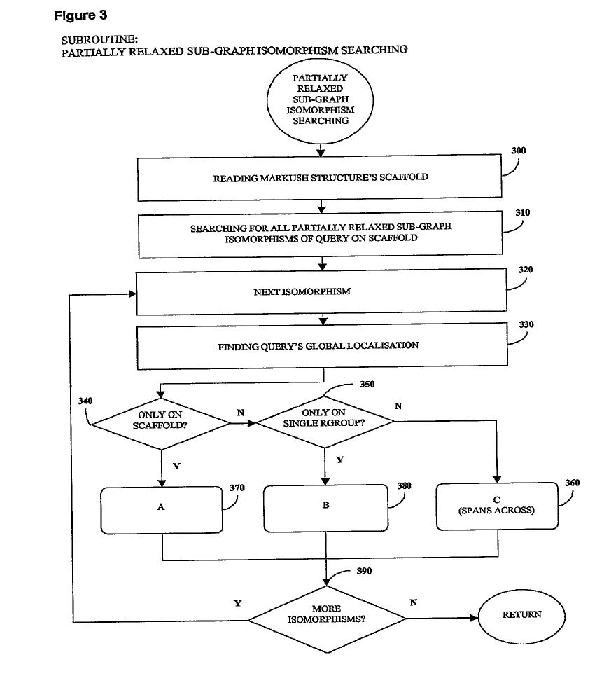

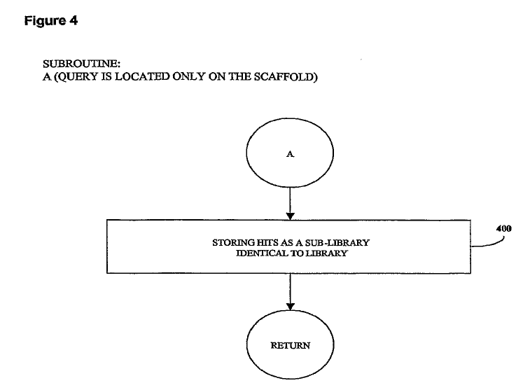

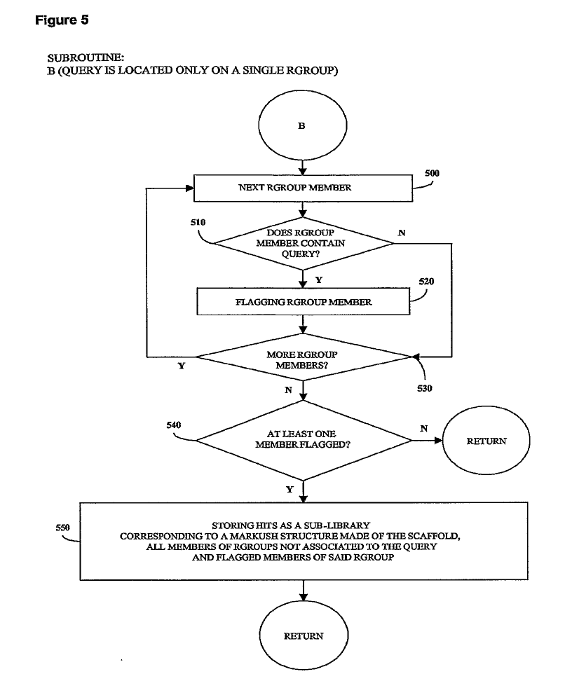

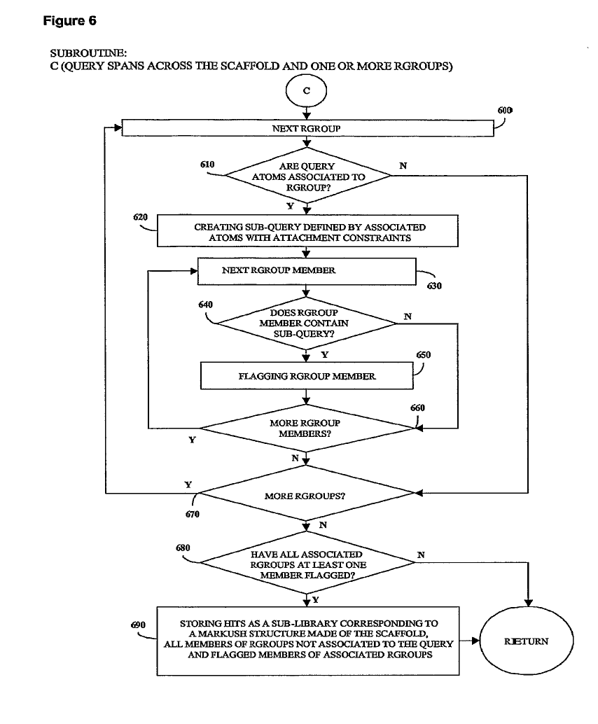

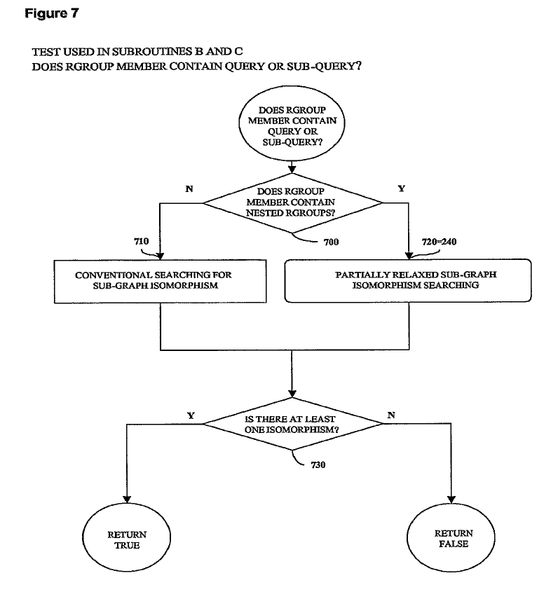

The present invention is now described by its different aspects and by its preferred methods or procedures. This description is performed with the help of flowcharts (FIGS. 2 to 7) illustrating the different aspects of the methods, and are to be considered as preferred embodiments of the present invention. Furthermore, in the figures, the different steps of the present invention have numbers allocated to them in order to clarify the following aspects and preferred methods or procedures (e.g. FIG. 2 contains number 200 corresponding to “Queries and Markush structures input”, number 210 corresponding to “Processing queries and Markush structures”, so on and so forth.)

In a first aspect of the invention, it provides a method of operating a computer for accomplishing the identification of all the product structures implicitly defined by at least one Markush structure (200, 220, 260), which is (are) stored in at least one database matching at least one given query structure (200), without the necessity of generating said product structures, comprising the steps of:
(i) Processing the Markush structure(s) and the query(ies) into a computer readable form (210),
(ii) Searching for partially relaxed subgraph isomorphism(s) for each query (230, 240, 250),
(iii) Retrieving data (270).

In a second aspect of the invention, it provides a computer program for accomplishing the automatic identification of all the product structures defined by one or more Markush structure(s), which is(are) stored in one or more database(s) matching one or more given query structure(s), without the necessity of generating the product structures, comprising computer code means adapted to perform all steps according to the first aspect of the invention when the program is run on a computer.

In a third aspect of the invention, it provides a computer readable medium having a program recorded thereon, where the program is to make the computer to carry out the method according to the first aspect of the invention.

In a fourth aspect of the invention, it provides a computer program product stored on a computer usable medium, comprising a computer readable program means for causing the computer to identify all the product structures defined by one or more Markush structure(s), which is(are) stored in one or more database(s) matching one or more given query structure(s), without the necessity of generating the product structures according to the first aspect of the invention.

In a fifth aspect of the invention, it provides a computer loadable product directly loadable into the internal memory of a digital computer, comprising software code portions for performing the steps of the first aspect of the invention when the product is run on a computer.

In a sixth aspect of the invention, it provides an apparatus for carrying out the method of the first aspect of the invention including data input means for inserting at least one given query characterized in that there are provided means for carrying out the steps of the first aspect of the invention.

In a seventh aspect of the invention, it provides a computer program according to the second aspect of the invention embodied on a computer readable medium.

In an eighth aspect of the invention, it provides a means to identify bioactive compounds (e.g.: drug compounds) by performing the method according to the first aspect of the invention.

Preferably, according to the first aspect of the invention, the given query structure is either an exact chemical structure or a chemical substructure.

Preferably, according to the first aspect of the invention, the query structure is said to match the product structure if the given query structure is exactly the product structure.

Preferably, according to the first aspect of the invention, the query structure is said to match the product structure if the given query structure is either the product structure or either a substructure of the product structure.

Preferably, according to the first aspect of the invention, the identification can be performed with the query structure as sole input (200), without the requirement of additional information to perform the identification.

Preferably, according to the first aspect of the invention, the generation of product structures is neither required before nor during the search.

Preferably, the processing of the Markush structure(s) and the query(ies) of step (i) according to the first aspect of the invention can either be performed before or either during the identification.

Preferably, according to the first aspect of the invention, the Markush structures can either be pre-processed (210) or processed during the identification. Preferably, according to the first aspect of the invention the query(ies) is(are) stored or not in a database.

Preferably, according to the first aspect of the invention, the database is made of at least one combinatorial library stored as a Markush structure (200). Most preferably, the libraries are each made of one scaffold and at least one R-group as constituents.

Still most preferably, the processing of the Markush structure(s) and the query(ies) of step (i) according to the first aspect of the invention comprises the steps of:
(a) Building of graphs and binary description of the scaffolds and R-groups,
(b) Building of graph and binary description of the query(ies).

Still most preferably, the binary description of the scaffolds and R-groups of step (a) above contains at least the following information:
1. For each scaffold:
   (c) Number of atoms present in the scaffold,
   (d) Graph of the scaffold,
   (e) Number of R-groups,
   (f) Label of the R-groups,
   (g) Position of the R-groups in the graph,
   (h) Number of neighbours for each R-group and position of the neighbours in the graph.
2. For each R-group:
   (a) R-group identification (ID),
   (b) Number of atoms present in the R-group,
   (c) Graph of the R-group,
   (d) Number of attachment points in the R-group,
   (e) Attachment points identification (atoms indexing),
   (f) Atoms involved in the attachment points.

Still most preferably, the partially relaxed subgraph isomorphism searching of step (ii) according to the first aspect of the invention (240) is performed on all the libraries and comprises the steps of:
(a) Scaffold reading (300),
(b) Partially relaxed subgraph isomorphism searching of the query against the scaffold (310),
(c) Processing of all isomorphisms (320 to 390),
for each library of the database (220, 260).

Even more preferably, the processing of all isomorphisms of step (c) above comprises the step of:
(1) Counting the number of atoms of the query associated with each constituent of the library (330),
(2) Identifying which atoms of the query are associated with the constituent(s) (330),
(3) Identifying on which constituent(s) the query is located (330),
(4) Processing of the isomorphism taking into account the query location determined in step (3) (340 to 380), for each isomorphism detected.

Still even more preferably, the identification on which constituent(s) the query is located, as set forth in step (3) above, defines the global localisation of the query on the library constituent(s) as being either only the scaffold (340), or either only one single R-group (350) or either the scaffold and at least one R-group (350). If the test (350) is negative, the query spans across the scaffold and at least one R-group, NESsea therefore proceeds with subroutine C (360).

Still even more preferably, the processing of the isomorphism of step (4) taking into account the query location comprises the steps of:
(i) Processing of the isomorphism if the query is only located on the scaffold of the library (370),
(ii) Processing of the isomorphism if the query is only located on a single R-group of the library (380),
(iii) Processing of the isomorphism if the query is located on the scaffold and at least one R-group of the library (360=all other cases)

Still even more preferably, when the query is only located on the scaffold of the library (370, the test 340 is positive), the processing of the isomorphism of step (i) above (370) comprises the step of storing the product structures according to the first aspect of the invention matching the query as a sub-library identical to the library (400).

Still even more preferably, when the query is only located on a single R-group of the library (350), the processing of the isomorphism of step (ii) above (380) comprises the steps of:
(a) Identifying members of the single R-group containing the query (500, 510, 530, 700 to 730),
(b) Flagging the members (520).

Still even more preferably, when the query is located on a single R-group of the library (380, the test 350 is positive), the product structures according to the first aspect of the invention matching the query are stored as a sub-library corresponding to a Markush structure made of the scaffold involved in the scaffold reading in the first step of the partially relaxed isomorphism searching according to the first aspect of the invention, all members of R-groups not associated to the query and the flagged members of the single R-group identified by the query in step (i) above (550), if the single R-group has at least one member flagged (540).

Still even more preferably, when the query is located on the scaffold and at least one R-group of the library, the processing of the isomorphism of step (iii) above (360) comprises the steps of:
(a) Identifying if atoms of the query are associated with an R-group (610),
(b) Isomorphism searching (640, 700 to 730) of the sub-query (620) formed by the atoms, on each member
(630, 660) of the associated R-group, if at least one atom is associated to the Rgroup (610),
(c) Flagging each member of the associated R-group for which at least one isomorphism is detected (650),
for each R-group of the library (600, 670).

Still even more preferably, when the query is located on the scaffold and at least one R-group of the library (360, the test 350 is negative), all members of a R-group of the library are flagged if the R-group is not involved in the partially relaxed sub-graph isomorphism searching of the query against the scaffold (310, step (b) of the partially relaxed isomorphism searching according to the first aspect of the invention).

Still even more preferably, when the query is located on the scaffold and at least one R-group of the library (360, the test 350 is negative), the product structures according to the first aspect of the invention matching the query are stored as a sub-library corresponding to a Markush structure made of the scaffold involved in the scaffold reading in the first step of the partially relaxed subgraph isomorphism searching according to the first aspect of the invention, all members of R-groups not associated to the query and the flagged members of the associated R-groups (690), if all the associated R-groups have at least one member flagged (680).

Still even more preferably, the above flagged members that match the sub-query are kept in a list for a specific isomorphism searching as IDs pointing to graphs. This particular procedure, method or subroutine enables the present invention to reduce storage space, thereby reducing information's access time as well as reducing hardware cost.

Still even more preferably, the association of atoms in the query with atoms in the scaffold is saved, defining the partial localisation of the query on the sub-library.

Still even more preferably, a same list of members is used for different R-groups of the library sharing the same members. This particular procedure, method or subroutine enables the invention to reduce storage space and searching time.

Still even more preferably, when the query is located on the scaffold and at least one R-group of the library (360), the sub-query isomorphism searching of step (b) above comprises the steps of:
(1) Building the sub-query to be searched in the associated R-group (620),
(2) Determining attachment point's constraints (620),
(3) Isomorphism searching (640, 700 to 730) with the attachment points' constraints for each of the associated R-group's member (630, 660).

Still even more preferably, when the query is located on the scaffold and at least one R-group of the library (360), graph connectivity of the sub-query is checked in the building of the sub-query in step (1) above, meaning that atoms associated to a given R-group make a connected graph.

Still even more preferably, when the query is located on the scaffold and at least one R-group of the library (360), the isomorphism searching with the attachment points' constraints of step (3) above is partially relaxed or not (720 or 710).

Still even more preferably, when the query is located on the scaffold and at least one R-group of the library (360), the determination of attachment points' constraints of step (2) above is defined as follows:
(i) For each neighbour C[i] of order i of the R-group in the scaffold, if the neighbour is associated to an atom of the query then D[i] represents the atom in the query, otherwise D[i]=Ø,
(ii) For each order i, if D[i] is defined then for each of the neighbour of D[i] in the query, if the neighbour is mapped to the R-group, A[i] represents the neighbour, otherwise A[i] is not defined (A[i]=Ø),
(iii) The array A represents the constraints of the attachment pints.

Still even more preferably, when the query is located on the scaffold and at least one R-group of the library (360), the isomorphism searching with the attachment points' constraints of step (3) above comprises the steps of:
(a) Reading the member (630),
(b) Searching of all the isomorphisms of the sub-query (640, 700 to 730) on the member with the constraints on attachment points: the atom A[i] of the sub-query must be mapped to the attachment point of order i of the member, for each i where A[i] is defined.

Still even more preferably, the number of isomorphisms is counted in the search of all the isomorphisms of the sub-query on the member with the constraints on attachment points in step (b) above.

Still even more preferably, the first isomorphism is searched in the search of all the isomorphisms of the sub-query on the member with the constraints on attachment points in step (b) above.

Still even more preferably, after the searching of all the isomorphisms of the sub-query (640, 700 to 730) in step (b) above, NESsea further comprises the step of saving all the isomorphism's descriptions, which defines, along with the partial localisation, the exact localisation of the query on the library.

Still even more preferably, the search of all the isomorphisms of the sub-query on the member with the constraints on attachment points in step (b) above (640, 700 to 730) comprises the additional steps of:
(i) Analysing each of the member for the presence of a nested R-group (700),
(ii) Proceeding recursively to the steps involved in the partially relaxed isomorphism searching of step (ii) according to the first aspect of the invention (720=240), with the query corresponding now to the sub-query, the scaffold corresponding now to the Rgroup and the R-groups are the nested ones, until the nested R-groups are no more involved in an isomorphism, if the member contains a nested R-group (700).

Preferably, the data retrieval of step (iii) according to the first aspect of the invention retrieves at least one of the following information:
For the entire database:
   Does the database contain the query or is there at least one library that contains the query? NESsea retrieves a yes or no answer. In other words, the database contains or does not contain the query or is there at least one library that contains the query,
   A list of all the combinatorial libraries containing the query,
   A list of all the combinatorial libraries not containing the query,
   A list and number of the scaffolds containing entirely the query,
   A list and number of scaffolds not containing entirely the query,
   A list and number of the R-groups containing entirely the query whether nested R-groups are allowed or not,
   A list and number of the R-groups not containing entirely the query whether nested R-groups are allowed or not,
   The total number of isomorphisms retrieved in the partially relaxed sub-graph isomorphism searching in step (b) (310) of the query against the scaffold for all the libraries, whether the associated R-groups identified in the steps involved in the processing of all isomorphisms (subroutines “partially relaxed subgraph isomorphism searching” and B or/and C) have at least one member flagged during this processing or not (540, 680),
   The global or partial localisation for all the isomorphisms,
   The first isomorphism found with or without its global or partial localisations,
For each library:
Does the library contain the query? NESsea retrieves a yes or no answer. In other words, the library contains or does not contain the query,
   A list and number of all the enumerated (specific) structures or non-e numerated structures of the library matching the query,
   The number of unique structures of the library matching the query, whatever the number of partial localisations of the query on the library,
   The number of times the query is located on the scaffold only, or on the R-groups only, or spans across the scaffold and tie R-group(s). This corresponds to the number of global localisations,
   The total number of isomorphisms retrieved in the partially relaxed subgraph isomorphism searching in step (b) (310) of the query against the scaffold, whether the associated R-groups identified in the steps involved in the processing of all isomorphisms (subroutines “partially relaxed subgraph isomorphism searching” and B or/and C) have at least one member flagged during this processing or not (540, 680). This corresponds to the total of the number of partial localisations of the query on the library,
   A list of all the partial localisations of the query on the library, each one corresponding to an isomorphism and defining a sub-library,
For each Rgroup:
   Does the R-group contain the query or the sub-query? A yes or no answer. NESsea retrieves a yes or no answer. In other words, the R-group contains or does not contain the query,
   A list and number of all the specific members or non-enumerated members of the R-group containing the query or the sub-query, whether nested R-groups are allowed or not,
   A list and number of all the specific members or non-enumerated members of the R-group not containing the query or the sub-query, whether nested R-groups are allowed or not,
   The number of times the query or sub-query is found in the R-group's members whether exact localisation or nested R-groups are taken into account or not. This corresponds to the total number of isomorphisms for all the R-group's members,
For each member of the R-group:
   Does the member contain the query or the sub-query?
   NESsea retrieves a yes or no answer. In other words, the member contains or does not contain the query,
   The number of times the query or sub-query is found on the member whether nested R-groups are taken into account or not. This corresponds to the number of isomorphisms of the sub-query on the member,
   A list and number of all the specific structures or non-enumerated structures described by the member containing the query or the sub-query if the member contain nested R-group(s),
   The exact localisation of the query or sub-query on the member,
For each single isomorphism of the query or sub-query:
   The library corresponding to the isomorphism,
   A list and number of R-groups associated to at least one atom of the query in the isomorphism,
   A list and number of R-groups not associated to any of the atoms of the query in the isomorphism,
   A list and number of members containing the query or the sub-query for each R-group,
   A list and number of members not containing the query or the sub-query for each R-group,
   The global localisation of the query on the library, i.e. the query is either only on the scaffold, or either only on one R-group or either on the scaffold and at least one R-group,
   The partial localisation of the query on the library, i.e. the atoms in the scaffold and the R-group(s) to which atoms in the query are mapped,
   A list of all the specific structures or non-enumerated structures containing the query and mapping on the library following the partial localisation,
For all the isomorphisms of the query or sub-query:
   All the information gathered in the aforementioned points.

Preferably, the data retrieval of step (iii) according to the first aspect of the invention retrieves the structures in the form of either enumerated or either non-enumerated structures.

Still preferably, the data retrieval of step (iii) according to the first aspect of the invention takes into accounts nested R-groups.

Still preferably, the data retrieval of step (iii) according to the first aspect of the invention takes into account the exact localisation of the query for each isomorphism.

Still preferably, according to the first aspect of the invention, screening technique(s) option(s) is applied. This particular procedure or method permits to the invention to reduce searching time.

Most preferably, such screening technique option relies on substructural features such as keys.

Still preferably, according to the first aspect of the invention, such method can be integrated in a pipeline. The invention therefore also encompasses the integration of NESSea with a set of tools.

Another advantage of the invention is that the NESSea search algorithm retrieves hits very fastly. As described in example 6, the present method operates nearly instantly using a set of 125 K structures. Even with a very large VCL (a 10⁹ molecules library), the present algorithm operates very quickly.

Still another advantage of the invention is that the NESSea search algorithm can work with librarie(s) that require very little data storage space (due to the particular mode of structure representation chosen). This particularity of the invention represents one of the reasons for its speed of search (see example 6).

Still another advantage of the invention is that NESSea can return hits as a set of sub-libraries, which are easy to store and which can be searched by substructure in their turn without the need for enumerating them.

It is understood that this invention is not limited to the particular methodology, protocols, implementations, interfaces and algorithms described. It is also to be understood that the terminology used herein is for the purpose of describing particular embodiments only and it is not intended that this terminology should limit the scope of the present invention. The extent of the invention is limited only by the terms of the appended claims. While the invention has been particularly shown and described with reference to a preferred embodiment thereof, it will be understood by those skilled in the art that various changes in form and details may be made therein without departing from the spirit and scope of the invention as defined by the appended claims.

Furthermore, it should be as well understood that in particular embodiments, the steps involved in this invention can be ordered differenty and can be as well repeated many times without departing from the spirit and scope of the invention as defined by the appended claims.

The practice of the present invention will employ, unless otherwise indicated, conventional techniques of computer and chemoinformatics skills that are within the skill of those working in the art.

Such techniques are explained fully in the literature. Examples of particularly suitable texts for consultation include the following: Structure Representation and Search, by J. M. Bamard. In Encyclopedia of Computational Chemistry, P. von Schleyer et al (Eds.), Wiley, Chichester (4), 2818-2826; Substructure Searching Methods: Old and New, by J. M. Barnard, J. Chem. Inf. Comput. Sci., 1993 (33), 532-538; Chemical Database Techniques in Drug Discovery, by M. A. Miller, Nature Reviews Drug Discovery, 2002 (1), 220-227; Advanced Exact Structure Searching in Large Databases of Chemical Compounds, Trepalin et al, J. Chem. Inf. Comput. Sci., 2003 (43), 852-860.

The purpose of the following embodiments and examples is to give a non-exhaustive list of applications of finding exact solutions to a structure query in non-enumerated chemical combinatorial libraries with the present method.

It should be understood that other programming languages, specific values (for setting values or default values of NESSea), implementations, associated or external programs, algorithms, formats, interfaces, outputs could be used in other embodiments in order to perform the invention. By no means these are to be considered as limiting factors and should therefore not limit the scope of the invention.

Fast, Low-Cost and Accurate Identification of the Hits in Combinatorial Libraries Resulting from a Substructure Query

Combinatorial chemistry is a tool allowing chemists to synthesise large numbers of compounds in a limited timeframe. As suggested by the name, it is based on the combination of different sets of building blocks bearing a common reactive moiety. These building blocks do theoretically undergo one and only one reaction under the experimental conditions when they are added to a system. Practically, an initial set of N building blocks usually reacts with a unique compound also termed scaffold, yielding to second generation of compounds. A new set of P building blocks is added to each system, yielding to N*P compounds, and so on and so forth. A complete synthesis may contain several such steps. It results in a set of products whose number grows as fast as the product of the numbers of building blocks in each set. It interestingly requires setting up only one synthetic scheme (see for instance Combinatorial Chemistry: A Practical Approach, Willi Bannwarth and Eduard Felder (ed), Wiley-VCH).

Thus, the size of combinatorial libraries may be an issue when they have to be stored in computerised systems. It also becomes a real problem when they have to be searched by substructure. Storing the libraries of compounds as their non-enumerated representation solves the first problem and represents one embodiment of the invention. This is actually the preferred method for enabling the storage of any combinatorial library. FIG. 1 shows one representation of libraries of compounds as non-enumerated structures.

However searching in a non-enumerated representation is not trivial. Several approaches have been developed and are reported in the background section. They either rely on using sampling methods or on enumerating the compounds just before they are searched but without storing them. The former takes advantage of the non-enumerated representation but it may forget to retrieve some substructures from the database. It is therefore not reliable for finding an exact list of hits. The latter yields an exact list but requires enumeration, which is a time-consuming operation.

The present invention can perform substructure searches as exact as if they were done on enumerated structures, but without the need for enumeration. Therefore, it represents an improvement over the existing methods since it requires fewer resources without decreasing the accuracy of the results. In addition, the present invention can return query hits as non-enumerated libraries, which can subsequently be enumerated, if needed. It is another advantage since the resources necessary for storing all the enumerated hits may be prohibitive in case of large libraries.

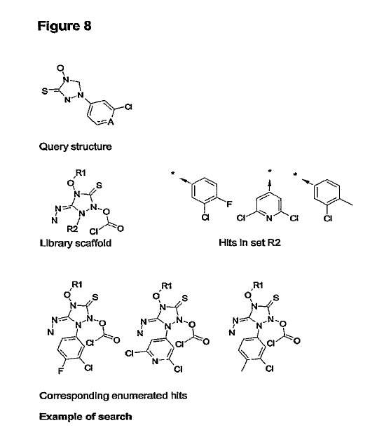

FIG. 8 is an example of search in which the query structure spans across the scaffold and the R2 set. In this example, R-group R1 is not involved and for clarity it has been denoted R1 in the list of hits. However, R1 can be replaced by any of its members, therefore increasing the total number of hits. Also, this example shows that hits can be represented either as a Markush structure (non-enumerated representation) or as a list of enumerated products representing specific embodiments of the invention.

Interestingly, the present method returns more information than just a list of hits. These other properties are detailed below.

The Use of Combinatorial Chemistry in Drug Discovery

Typical applications of combinatorial chemistry in drug discovery are two-fold:
Synthesise large number of diverse compounds for screening purposes.
Synthesise a lot of similar compounds focussed around a substructure known or likely to be active on a biological target or a series of targets.

The biological activity of these compounds is then assessed and potential hits or leads are identified.

These approaches have proven to be successful in many cases. However, even if combinatorial chemistry is characterised by its high throughput, the number of compounds traditionally produced (few hundreds to several tens of thousand) is still very small compared to the goggle of compounds possibly of interest to the pharmaceutical industry (10ˆ40) (See Merlot C., Domine D., Cleva. C., Church D., Drug Discovery Today, July 2003, v8, n13, p594). Retrospectively, its success was mainly due to the experience of chemists who designed libraries and particularly in the way they selected the scaffolds (the central part of the library) and the building blocks. Thus, many current applications of combinatorial chemistry focus on designing in a rational way, rather than trying to synthesise every possible compound.

One of the most widely used approaches to design a successful combinatorial library is to generate one or several virtual libraries and to refine them before they are actually synthesised. This refining step is advantageously conduced by the mean of in-silico prediction tools such as the use of privileged substructures. Privileged substructures are chemical moieties that are deemed to procure a biological activity to the compounds in which they are found, or at least, that increase the chance of having those compounds active (see Merlot C., Domine D., Church D., Current Opinion in Drug Discovery & Development, 2002 5(3):319-399 for a review). Focussing on privileged substructures represents therefore a valuable mean for prioritising compounds to synthesise and to assay. However, the substructures used to filter virtual combinatorial libraries are not limited to privileged substructures issued from computational methods, but can have been manually identified by an operator based on patents, experience, or experiments. In the following, they will be referred to as the query structure.

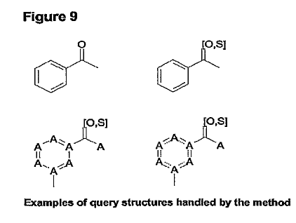

Some examples of query structures are shown in FIG. 9 representing particular embodiments of the invention. Query structure A is specific, while in structure B hits may contain either an oxygen or a sulphur atom instead of the pseudo-atom [0,S]. In structure C the ring may contain any kind of atom and in structure D constraints on the bonds are relaxed: bonds in the rings can be single/double or aromatic. The query may also include features such as a limitation on the number of substitutions, a requirement on the number of H, or formal charges.

In a common embodiment, all the compounds for each virtual library are enumerated. The presence of the query structure is then evaluated within the enumerated products and the corresponding building blocks selected.

In this context, the present method can be usefully applied in order to focus on the most interesting libraries, and for each library, to focus on the most interesting building blocks that will be used for the actual synthesis. If the query structure is found in the virtual library, the method will return the sub-libraries of compounds in which it is contained (see example 1). The present method is said to be exact because each member of the sub-libraries contains the query structure and none of the compounds that were not returned contains it. Thus, provided that the query structure has been chosen with care, the sub-libraries contain compounds with a high chance of being active. It becomes therefore more profitable to spend some time to try to find a valid synthetic scheme for these sub-libraries. This operation is also made easier because fewer building blocks are involved in the synthesis.

The present method for searching a query structure is the only one to our knowledge to be able to search in non-enumerated combinatorial libraries representing as much as 10ˆ15 compounds in only a few seconds. Such searches would be impractical with standard systems. This advantage is due to the direct processing of non-enumerated libraries without the need for enumerating before and then searching in each individual compound. In the present method, the time required to do a search grows as the sum of the number of members in each set of building blocks, while a search in enumerated libraries grows as the product of the number of members in each set of building blocks. For instance, a library made of five sets of 1,000 building blocks each, contains 10ˆ15 compounds. Searching in such a library would take 5,000 (5*1000) unit of times instead of 10ˆ15, resulting in an improvement of 11 orders of magnitude.

Removing Unnecessary Building Block Sets from Synthetic Schemes

Interestingly, one of the advantages of having hits in a non-enumerated representation is that it is then possible to display the sets of building blocks involved in the query without the need for any subsequent operation.

The method identifies the sets that are not involved in the query without the need for any further processing (see example 2). This information is valuable for planning which compounds to synthesise because such sets might be removed, as they are not deemed to be necessary for the biological interaction. In particular, their removal can ease the synthesis if they would have introduced side-reactions with other chemical reactants.

Localising the Query on a Library

If the query structure can be found at different locations in the compounds represented by a library, the present method identifies all of these different locations and lists them as different sub-libraries. This localisation corresponds to the partial localisation defined in the claims.

It is also valuable for an experienced user to visualise how the query structure is mapped on each of those sub-libraries. This operation completes the information returned by the substructure search. One reason behind is that a query substructure may not contain all the information necessary for predicting the biological activity of a compound. Steric hindrance is typically one of the main effects involved in biological interactions that is difficult to encode into a query structure.

As the present method associates the localisation of the query structure to the sub-libraries returned rather than to individual compounds, it becomes faster to examine how the structure of interest is found in compounds. The operator can therefore effectively perform this check and correct some of the issues related to query structures.

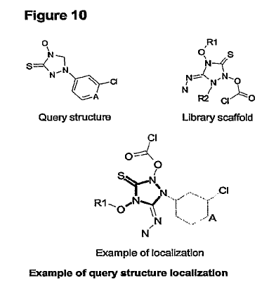

FIG. 10 shows an example of mapping the query structure of FIG. 8 onto the library described in the same figure. It shows how the atoms in the query are mapped to atoms in the scaffold (drawn in bold) and represents one possible embodiment of the invention. This type of localisation corresponds to the partial localisation defined in the claims. I It shows their environment in the scaffold. This localisation allows the user to evaluate the value of all the products of such a sub-library at a glance. The six-membered ring (drawn in dashes) corresponds to the portion of the query structure that is mapped to set R2. Not showing how this six-membered ring is exactly mapped on the R2 building blocks is not usually an issue since it will be instanced in many different ways depending on the members of R2. Query structure localisation also shows that R1 building block set is not involved in the query (see example 5).

Iterative Queries

Query structures are sometimes expressed as the combination of two or more disconnected substructures. In that case, the expected result is the list of compounds that simultaneously contain all said substructures.

In an embodiment of the present method, the search may be applied recursively to obtain libraries whose compounds bear all substructures. The first substructure is searched in the whole library and each subsequent substructure is then searched in the results of the previous step.

The present invention facilitates this operation because it returns hits as non-enumerated libraries, which is exactly the input it needs to perform the subsequent queries. Its main characteristics such as high speed and low storage resources are thus preserved in all recursion levels.

Combining Results with Logical Operations

Alternatively, in another embodiment of the invention, iterative queries can be replaced by logical “AND” operations on non-enumerated sub-libraries. Such operations are particularly easy and fast since the combination of two sub-libraries of the same library with the ‘AND’ operator is the sub-library in which each set of building bocks consists in the building backs common to both sub-libraries. Practically any iterative query pan be replaced by a set of parallel queries, followed by the application of the logical “AND” operator on the resulting sub-libraries (see example 3).

Counting the Occurrence of the Query in a Final Product

It is valuable to determine how many times a query structure can be found in a final product. The rationale behind this is that multiplying the occurrence of said query substructure in the final product multiplies the chances of having the compound active in the biological assay.

This could be solved by combining different sub-libraries linked to a same query structure, as it has been described in the preceding section. When a product is found in several sub-libraries, it means that there are different mappings of the query on said product.

More accurately, the number of times the query structure can be found on a given product in a given sub-library is equal to the product for the different sets of building blocks of the number of times the sub-query corresponding to said set is found in the building block for said product. If this compound is present in several sub-libraries, the total occurrence of the query structure in this product is the sum of the occurrences for all sub-libraries.

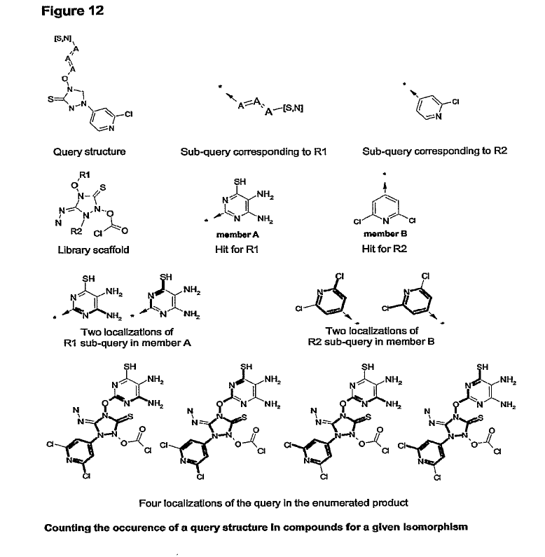

FIG. 12 shows an example where the sub-query structure corresponding to the set of building blocks R1 is found twice in member A and the sub-query structure corresponding to the set of building blocks R2 is found twice in member B (representing one embodiment of the invention). As a result, the query is found 2×2=4 times in the enumerated product. As there is only one way to map the query structure on the library in this example, the total occurrence of the query structure on product equals 4.

Removing Unwanted Substructures from Libraries

The “NOT” operator is another example of supported logical operators that can be advantageously applied in the drug discovery process, representing another embodiment of the invention. For example, a major concern of pharmaceutical companies and biotechs is the high attrition rate of compounds during the clinical development, and more particularly the failures due to unwanted properties such as toxicity, carcinogenicity or lack of selectivity. The number of these failures is expected to decrease with the rationalisation of the drug discovery process.

A computational approach consists in searching for unwanted moieties in the virtual combinatorial library. A penalty is then given to the compounds in which unwanted substructures are found. The priority given to those compounds will therefore decrease, even if they contain a privileged substructure. In this process, unwanted moieties may be associated either to toxic effects (to prevent toxicity, carcinogenicity, or any other undesirable biological action) or other biological receptors (to improve the selectivity of the compounds for the target over said receptors).

In an embodiment of this method, each structure associated to an unwanted property is searched and stored. When a sub-library is selected based on the presence of a wanted query structure, it is then filtered and all the compounds associated to the unwanted property are removed. This operation is termed “logical NOT” because the results contain all the members of the first set that are not present in the second.

Working with non-enumerated libraries of hits makes this operation simple and fast since the combination of two sub-libraries of the same library with the logical operator “NOI” is a set of sub-libraries describing the set of building blocks of the first sub-library that are not found in the set of building blocks of the second sub-library (see example 4).

Assembling Huge Virtual Combinatorial Libraries

Virtual combinatorial libraries can be built for a given purpose and then refined using the present method as it has been described previously. Such libraries are termed focussed virtual libraries. Alternatively, virtual combinatorial libraries can be constructed without any immediate application in mind and stored in a database. This approach is closer to the initial aim of combinatorial chemistry of synthesising large number of diverse compounds for screening purposes.

When a new query substructure has been identified for a target of interest, it is searched in each virtual combinatorial library. The virtual sub-libraries made of compounds containing the query substructure are then processed. Processing may include, but is not limited to, any refinement method described before.

Other Fields of Applications

The use of the present method is not limited to the drug discovery process. It can be applied and all the advantages described remain valid in all the cases where a query structure of interest has to be searched in a database of combinatorial libraries. In particular, it has several other fields of application, such as the identification of novel chemicals in the field of agrochemistry, olfaction, and taste.

Searching for a Structure in Patents

Since the introduction in the 1920's of generic structures in patents by Markush (hence the name of Markush structures), searching for structures protected by patents has been a major interest. The present method can achieve this objective under specific conditions.

Provided that Markush structures can be represented as combinatorial libraries, the method described here is able to detect whether a query structure is included in the Markush structure protected by a patent.

In addition, it is able to return the exact number and the structure of each of the compounds described by the Markush structure that contain said query structure.

### EXAMPLES

### Example 1

The method of the invention has been run on a computer to retrieve the sub-libraries containing a given query structure (one query structure as input).

Table 1 shows different examples of sub-libraries corresponding to the search of a query structure in a unique combinatorial library named CL0001. The sub-libraries as indicated in Table 1 are exact because each member of the sub-libraries contains the query structure. The first two sub-libraries correspond to mapping the query structure on the scaffold and set R1 (respectively R2). In the third sub-library, the query spans across the scaffold, R1 and R2 simultaneously. The fourth and fifth sub-libraries are special cases where the query is entirely mapped on either the scaffold or R1. The type of localization indicated in the column designated “Type” corresponds to the global localization of the query. In all cases, the method displays the number of members matching the query for each mapping, and also stores the list of members.

TABLE 1
examples of sub-libraries corresponding to the search of a query
structure in a unique combinatorial library named CL0001

| Sub-library ID | Library name | Type | R1 | R2 |
|---|---|---|---|---|
| 9/700/1 | CL00001 | Spans | 287 | Any |
| 9/700/2 | CL00001 | Spans | Any | 56 |
| 9/700/3 | CL00001 | Spans | 33 | 87 |
| 9/700/4 | CL00001 | Fully on scaffold | Any | Any |
| 9/700/5 | CL00001 | Fully on rgroup | 2534 | Any |

Table 2 and Table 3 are screenshots representing examples of different sublibraries involving many libraries, the global localization of the query, the number of members matching the query for each mapping, and shows a link for the possible enumeration of structures. All the sub-libraries of a particular library have been grouped together for visualization purposes.

TABLE 2
Screenshot of examples of sub-libraries corresponding to the search of a query
structure in a plurality of combinatorial libraries.

| | | | | | | | | |
|---|---|---|---|---|---|---|---|---|
| 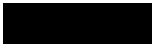 | 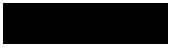 | 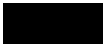 | 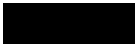 | 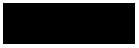 | 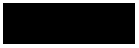 | 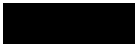 | 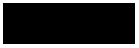 | 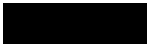 |
| 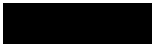 | 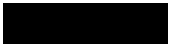 | 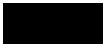 | 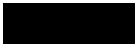 | 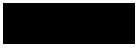 | 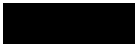 | 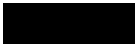 | 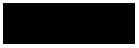 | 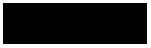 |
| 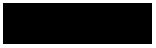 | 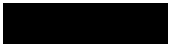 | 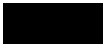 | 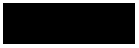 | 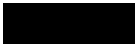 | 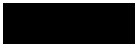 | 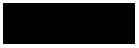 | 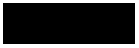 | 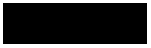 |
| 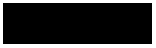 | 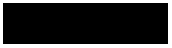 | 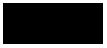 | 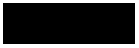 | 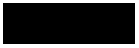 | 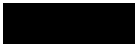 | 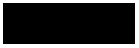 | 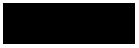 | 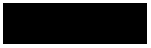 |
| 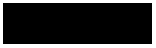 | 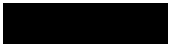 | 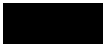 | 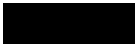 | 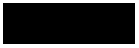 | 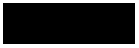 | 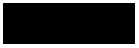 | 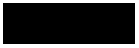 | 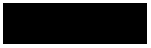 |
| 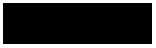 | 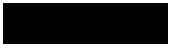 | 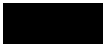 | 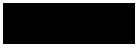 | 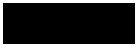 | 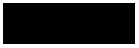 | 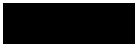 | 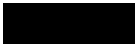 | 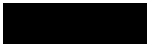 |
| 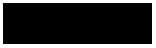 | 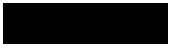 | 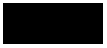 | 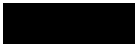 | 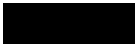 | 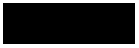 | 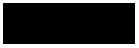 | 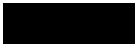 | 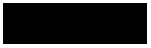 |
| 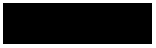 | 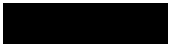 | 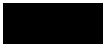 | 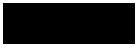 | 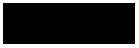 | 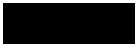 | 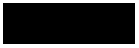 | 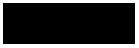 | 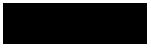 |
| 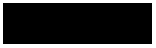 | 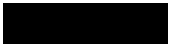 | 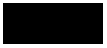 | 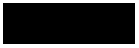 | 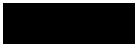 | 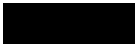 | 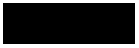 | 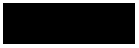 | 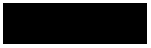 |
| 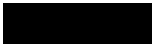 | 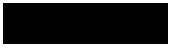 | 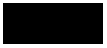 | 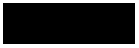 | 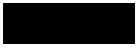 | 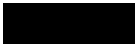 | 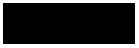 | 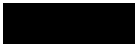 | 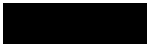 |
| 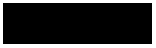 | 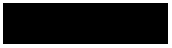 | 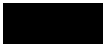 | 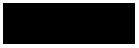 | 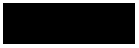 | 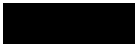 | 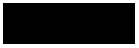 | 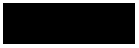 | 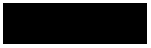 |
| 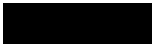 | 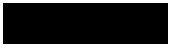 | 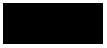 | 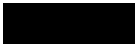 | 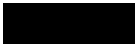 | 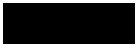 | 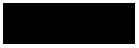 | 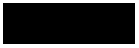 | 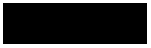 |
| 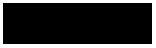 | 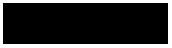 | 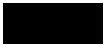 | 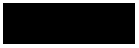 | 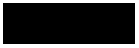 | 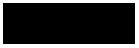 | 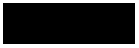 | 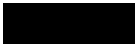 | 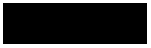 |
| 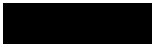 | 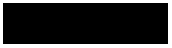 | 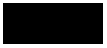 | 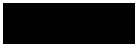 | 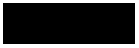 | 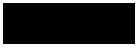 | 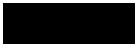 | 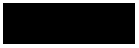 | 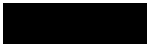 |
| 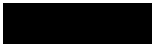 | 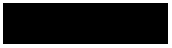 | 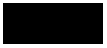 | 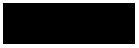 | 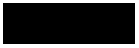 | 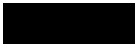 | 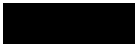 | 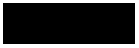 | 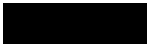 |
| 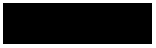 | 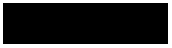 | 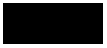 | 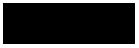 | 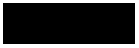 | 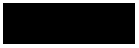 | 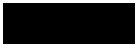 | 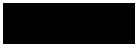 | 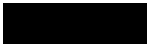 |
| 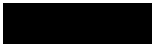 | 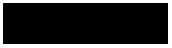 | 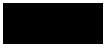 | 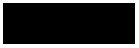 | 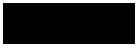 | 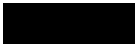 | 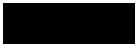 | 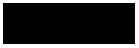 | 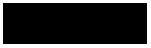 |
| 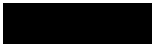 | 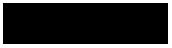 | 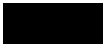 | 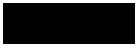 | 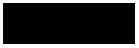 | 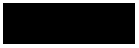 | 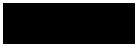 | 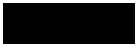 | 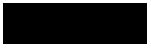 |

TABLE 3
Screenshot of examples of sub-libraries corresponding to the search of a query
structure in a plurality of combinatorial libraries. This table further indicates the three
kinds of global localization of a query: only on the scaffold (indicated in Table 3 by “Fully
on scaffold”) or spanning across the scaffold and at least one R-group (indicated in table
3 by “Spans”) or only on a R-group (indicated in table 3 by “Fully on rgroup”).

| | | | | | | | | |
|---|---|---|---|---|---|---|---|---|
| 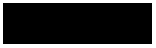 | 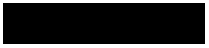 | 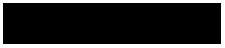 | 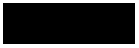 | 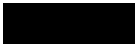 | 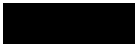 | 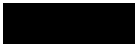 | 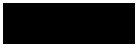 | 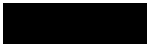 |
| 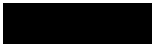 | 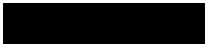 | 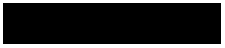 | 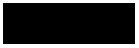 | 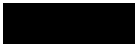 | 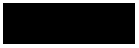 | 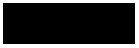 | 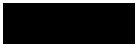 | 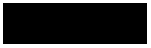 |
| 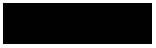 | 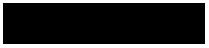 | 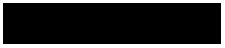 | 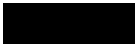 | 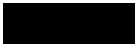 | 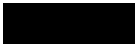 | 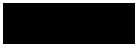 | 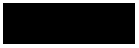 | 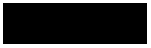 |
| 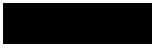 | 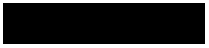 | 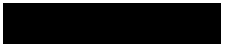 | 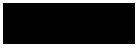 | 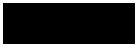 | 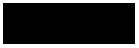 | 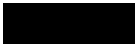 | 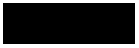 | 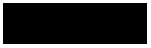 |
| 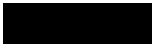 | 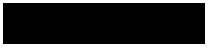 | 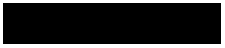 | 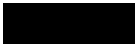 | 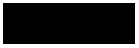 | 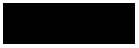 | 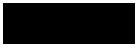 | 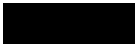 | 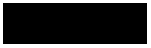 |
| 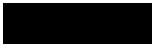 | 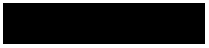 | 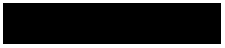 | 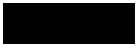 | 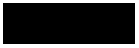 | 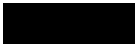 | 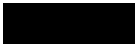 | 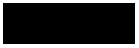 | 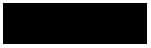 |
| 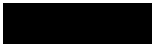 | 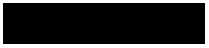 | 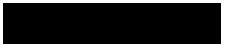 | 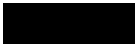 | 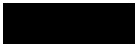 | 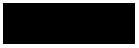 | 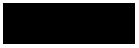 | 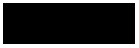 | 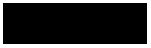 |
| 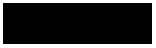 | 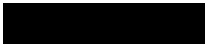 | 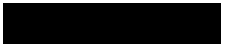 | 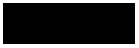 | 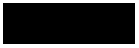 | 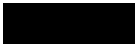 | 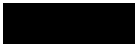 | 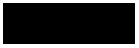 | 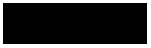 |
| 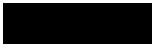 | 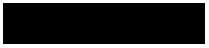 | 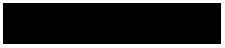 | 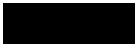 | 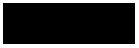 | 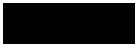 | 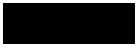 | 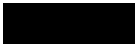 | 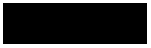 |
| 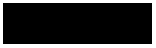 | 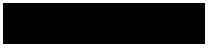 | 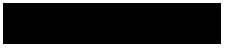 | 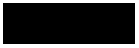 | 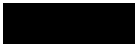 | 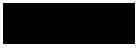 | 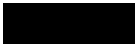 | 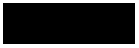 | 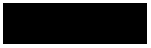 |
| 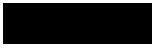 | 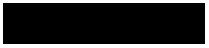 | 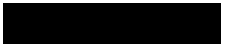 | 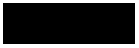 | 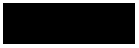 | 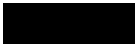 | 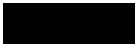 | 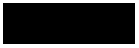 | 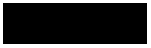 |
| 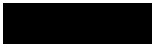 | 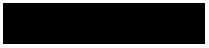 | 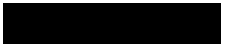 | 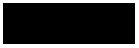 | 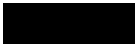 | 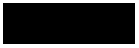 | 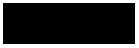 | 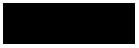 | 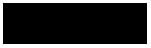 |
| 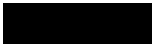 | 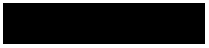 | 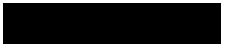 | 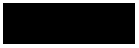 | 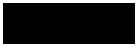 | 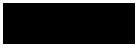 | 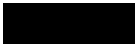 | 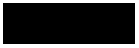 | 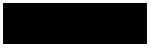 |
| 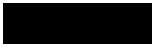 | 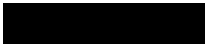 | 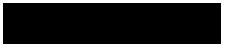 | 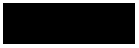 | 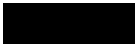 | 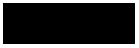 | 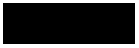 | 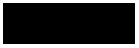 | 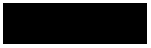 |

### Example 2

The method of the invention has been run on a computer to show an unnecessary set of building blocks in a retrieved sub-library (one query structure as input).

Table 4 shows two examples in which several building blocks of R1 can make the final product to bear the query structure. However all those building blocks are not equivalent. For example, any of the 287 building blocks is enough to find the query structure on the product once it has been attached to the scaffold. This is true whatever the R2 building block. On the other hand, R1 building blocks in sub-library “9/700/3” must be combined with one of the 87 R2 building blocks to have the same result. Similarly, Table 6 is a screenshot showing several building blocks of R2 that can make the final product to bear the structure.

TABLE 4
examples of different types of building blocks of R1 that
can make the final product to bear the query structure

| Sub-library ID | Library name | Type | R1 | R2 |
|---|---|---|---|---|
| 9/700/1 | CL00001 | Spans | 287 | Any |
| 9/700/3 | CL00001 | Spans | 33 | 87 |

In Table 5, the step consisting of adding the R2 building blocks may be skipped without decreasing the chances of having the final product active. This is of particular interest if the building blocks present in the R2 set can make side reactions.

TABLE 5
example where R2 building blocks can be skipped

| Sub-library ID | Library name | Type | R1 | R2 |
|---|---|---|---|---|
| 9/700/1 | CL00001 | Spans | 287 | Any |

In the first line of Table 6, the step consisting of adding R1 building blocks may be skipped.

TABLE 6
Screenshot of examples of different types of building blocks of R2 that can
make the final product to bear the query structure. The first line of table 6 corresponds to
an example where R1 building blocks can be skipped.

| | | | | | | | | |
|---|---|---|---|---|---|---|---|---|
| 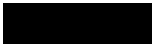 | 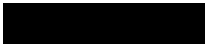 | 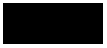 | 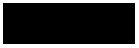 | 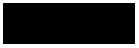 | 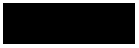 | 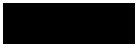 | 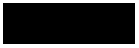 | 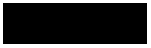 |
| 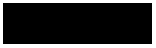 | 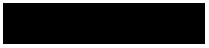 | 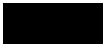 | 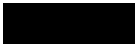 | 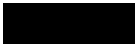 | 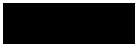 | 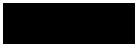 | 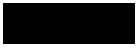 | 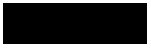 |

### Example 3

The method of the invention has been run on a computer to show the results of the logical operator “AND” on two sub-libraries.

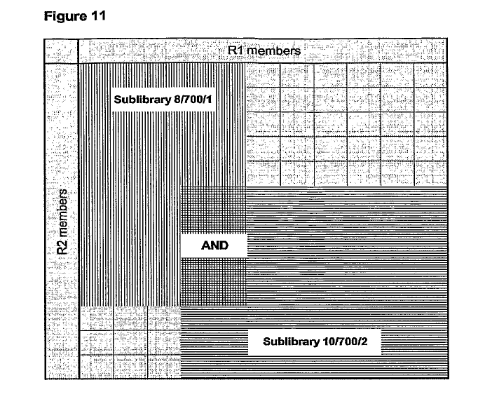

Table 7 shows two sub-libraries of the same library CL00001 matching different query structures. FIG. 11 represents them as an array, the first sub-library drawn with vertical lines and the second one with horizontal lines. The overlap of these two sub-libraries is hashed. These two sub-libraries have in common two members of R1 and five members of R2. As a result, the intersection of the two sub-libraries is the sub-library of CL00001 displayed in hashed and made of said two members of R1 and said five members of R2 (Table 8).

TABLE 7
sub-libraries of the same library CL00001
matching different query structures

| Sub-library ID | Library name | Type | R1 | R2 |
|---|---|---|---|---|
| 8/700/1 | CL00001 | Spans | 5 | 10 |
| 10/700/2 | CL00001 | Spans | 8 | 8 |

TABLE 8
intersection of the two sub-libraries of Table 7

| Sub-library ID | Library name | Type | R1 | R2 |
|---|---|---|---|---|
| 10/700/1 AND 10/700/2 | CL00001 | Spans | 2 | 5 |

### Example 4

The method of the invention has been run on a computer to show the results of the logical operator “NOT” on two sub-libraries for the removal of unwanted substructures from libraries.

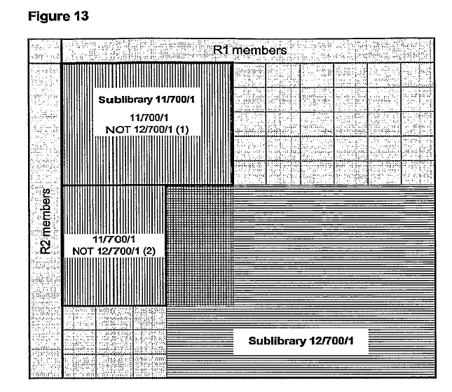

In the following example, all the products matching a wanted query structure are returned in a single sub-library 11/700/1 of library CL00001 (Table 9). In parallel an unwanted query structure returns a sub-library called 12/700/1 of unwanted compounds of CL00001 (Table 9). These two sub-libraries are represented with vertical and horizontal lines respectively in FIG. 13. Compounds belonging to both sub-libraries are hashed. Therefore, compounds bearing the wanted query structure and in which the unwanted query structure is not found are those represented with vertical lines only. Those compounds can be represented as two non-enumerated sub-libraries as shown in Table 10.

TABLE 9
sub-libraries of the same library CL00001
matching different query structures

| Sub-library ID | Library name | Type | R1 | R2 |
|---|---|---|---|---|
| 11/700/1 | CL00001 | Spans | 5 | 10 |
| 12/700/1 | CL00001 | Spans | 8 | 8 |

TABLE 10
sub-libraries resulting from the NOT operation

| Sub-library ID | Library name | Type | R1 | R2 |
|---|---|---|---|---|
| 11/700/1 NOT 12/700/1 (1) | CL00001 | Spans | 5 | 5 |
| 11/700/1 NOT 12/700/1 (2) | CL00001 | Spans | 3 | 5 |

### Example 5

The method of the invention has been run on a computer to illustrate some of the possible steps involved by a query substructure search in a virtual chemical library. This search corresponds to the “example of search” as illustrated in FIG. 8 and discussed in the section “Fast, low-cost and accurate identification of the hits in combinatorial libraries resulting from a substructure query” above.

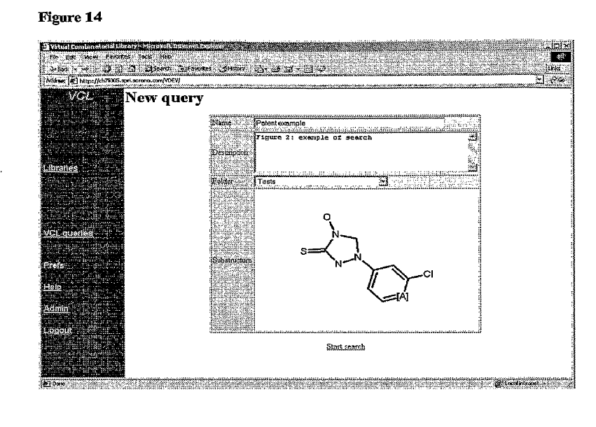

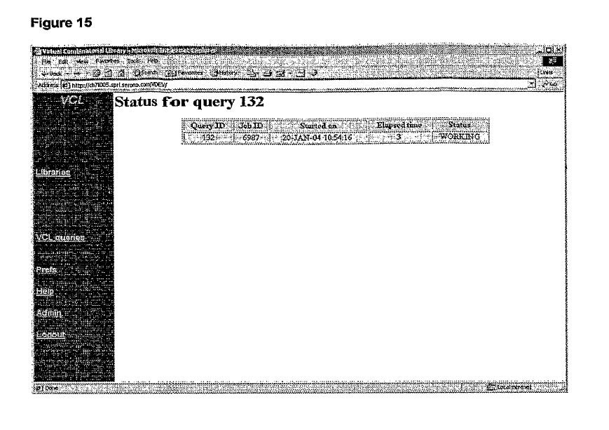

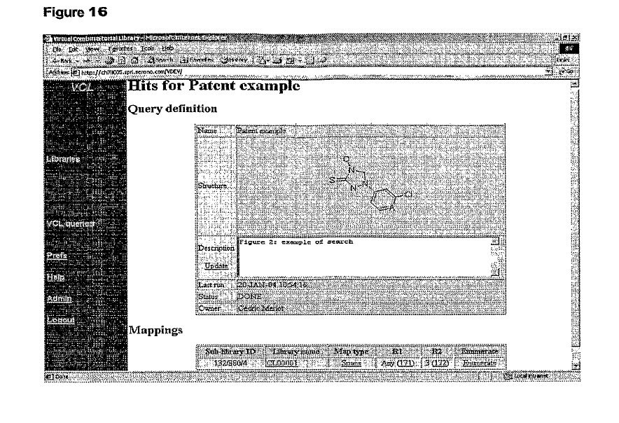

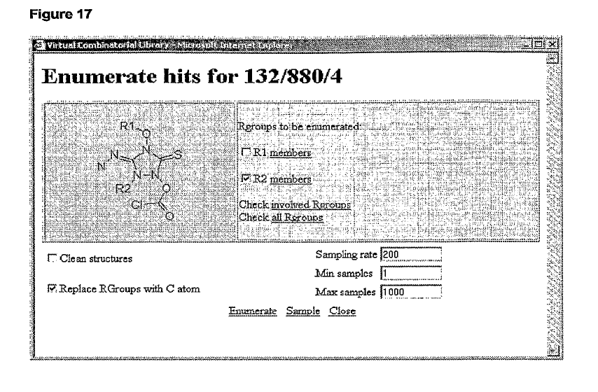

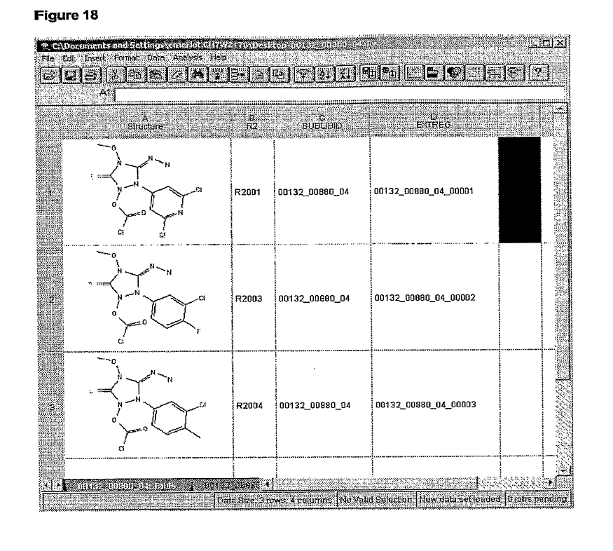

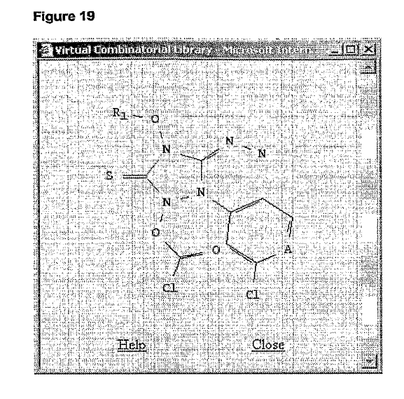

The different figures (FIGS. 14 to 19) showing screenshots describe the following possible features or embodiments of the present invention:
One given query structure according to the first aspect of the invention (FIG. 14),
The current status of the job processed (FIG. 15),
Results or hits from the query identified by the section “Mappings” (FIG. 16, similar to the screenshots of the above examples)
Possible options allowed before enumeration of a particular sub-library (FIG. 17),
Enumeration of structures involving the R2 set (FIG. 18) and
Partial localization of the query structure on a particular R-group member (FIG. 19, representation in colours).

Results indicate that the query structure is contained in each member of the Sub-Library ID 132/880/4 of CL00001 Library (ID 132/880/4 is as such an exact sub-library, FIG. 16), that the query structure spans across the scaffold and the R2 set and that 3 members of the R2 set are involved.

FIG. 14 corresponds to the “Query structure” of FIG. 8. The structure of FIG. 17 corresponds to the “Library scaffold” of FIG. 8. FIG. 18 corresponds to the “Corresponding enumerated hits” of FIG. 8. The three enumerated structures result from the respective association of the three members of the R2 set to the scaffold.

FIG. 19, which represents the partial localization of the query structure on one of the above-enumerated structures, is obtained by clicking on “Spans” (global localization of the query structure) of the column “Map Type” of FIG. 16.

### Example 6

In order to evaluate the performance of NESSea in terms of rapidity of execution, a test was performed to compare NESSea with the search algorithm of the MDL's Project Library (industry standard) using a set of 125 K structures.

A comparison can only be performed with such types of small libraries as no other tools can handle large VCL (the purpose of the present invention).

Results can be subdivised in three categories, which reflect the outstanding performance of the present invention in terms of rapidity of execution and data storage occupancy:
Data storage space of the 125 K structures in the MDL's Project Library represents 250 MegaBytes (MB) which is to be compared with the 0.1 MB needed to represent the same library with the Markush representation of the present invention.
The search algorithm used by MDL requires enumeration of the structures, which took approximately 10 hours. The present invention doesn't require enumeration.
It took approximately 30 seconds for the substructure search in MDL, compared with the nearly instantaneous search with the present invention's algorithm.

In addition, NESSea was used to perform a search in an in-house large VCL of approximately 10⁹ molecules. Even with such a large library, the present invention could operate nearly instantaneously.

Results are summarized below:

| MDL Project Library | NESSea |
|---|---|
| Enumeration: 10 h | No enumeration |
| Storage space: 250 MB | Storage space: 0.1 MB |
| Time for a SSS: 30 s | Time for a SSS: instant. |

The present invention seems therefore particularly adapted for searches in large VCL. Furthermore, the requirement for insignificant data storage space and for conventional computational resources makes NESSea also particularly suitable for all kind of computers, thereby reducing hardware costs.

### REFERENCES

1. Virtual Compound Libraries: A New Approach to Decision Making in Molecular Discovery Research, by R. D. Cramer, D. E. Patterson, R. D. Clark, F. Soltanshabi, and M. S. Lawless, J. Chem. Inf. Comput. Sci., 1998, (38), 1010-1023
2. Fragment Analysis in Small Molecule Discovery, by C. Merlot, D. Domine, D. J. Church, Current Opinion in Drug Discovery & Development, 2002, (5/3), 391-399
3. In Electronic Dissertation Library, http://panizzi.shef.ac.uk/elecdiss/edl0002/litreva.html
4. Substructure Searching Methods: Old and New, by J. M. Barnard, J. Chem. Inf. Comput. Sci., 1993, (33), 532-538
5. U.S. Pat. No. 5,418,944
6. U.S. Pat. Nos. 5,577,239, 5,950,192, and 6,304,869.
7. Chemical Database Techniques in Drug Discovery, by M. A. Miller, Nature Reviews Drug Discovery, 2002, (1), 220-227
8. MACCS keys
9. Generic Queries in the MACCS System, by W. T. Wipke, J. G. Nourse, T. Moock in Barnard, J. M. (Ed.) Computer Handling of Generic Chemical Structures, Gower, Aldershot, 1984, pp 167-178
10. Managing the Combinatorial Explosion, by B. A. Leland, B. D. Christie, J. G. Nourse, D. L. Grier, R. E. Carhart, T. Maffet, S. M. Welford, D. H. Smith, J. Chem. Inf. Comput. Sci., 1997, (37), 62-70
11. Computer Storage and Retrieval of Generic Chemical Structures in Patents. 1. Introduction and General Strategy, by M. F. Lynch, J. M. Barnard, and S. M. Welford, J. Chem. Inf. Comput. Sci., 1981, (21), 148-150.
12. Computer Storage and Retrieval of Generic Chemical Structures in Patents. 2. GENSAL, a Formal Language for the Description of Generic Chemical Structures, by J. M. Barnard, M. F. Lynch, and S. M. Welford, J. Chem. Inf. Comput. Sci., 1981, (21), 151-161.
13. Computer Storage and Retrieval of Generic Chemical Structures in Patents. 3. Chemical Grammars and their Role in the Manipulation of Chemical Structures, by S. M. Welford, M. F. Lynch, and J. M. Barnard, J. Chem. Inf. Comput. Sci., 1981, (21), 161-168.
14. Computer Storage and Retrieval of Generic Chemical Structures in Patents. 4. An Extended Connection Table Representation for Generic Structures, by J. M. Barnard, M. F. Lynch, and S. M. Welford, J. Chem. Inf. Comput. Sci., 1982, (22), 160-164
15. Computer Storage and Retrieval of Generic Chemical Structures in Patents. 5. Algorithmic Generation of Fragment Descriptors for Generic Structure Screening, by S. M. Welford, M. F. Lynch, and J. M. Barnard, J. Chem. Inf. Comput. Sci., 1984, (24), 57-66
16. Computer Storage and Retrieval of Generic Chemical Structures in Patents. 6. An Interpreter Program for the Generic Structure Description Language GENSAL, by J. M. Barnard, M. F. Lynch, and S. M. Welford, J. Chem. Inf. Comput. Sci., 1984, (24), 66-71
17. A Unique Chemical Fragmentation System for Indexing Patent Literature, by M. Z. Balent, J. M. Emberger, J. Chem. Inf. Comput. Sci., 1975, (15), 100-104
18. Chemical Structure Searching in Derwent's World Patents Index, by S. M. Kaback, J. Chem. Inf. Comput. Sci., 1980, (20), 1-6
19. The GREMAS System, an Integral Part of the IDC System for Chemical Documentation, by S. Rossler, and A. Kolb, J. Chem. Doc., 1970, (10), 128-134
20. Gleaning Patents with Chemical Abstracts, by R. J Rowlett, ChemTec. 1979, June, 348-349
21. Present and Future Prospects for Structural Searching of the Journal and Patent Literature, by J. A. Silk, J. Chem. Inf. Comput. Sci., 1979, (19), 195-198.
22. EP 196 237
23. Chemical Substance Retrieval System for Searching Generic Representations. 1. A Prototype System for the Gazetted List of Existing Chemical Substances in Japan, by Y. Kudo and H. Chihara, J. Chem. Inf. Comput. Sci, 1983, (23), 109-117.
24. A Comparison of Different Approaches to Structure Handling, by J. M. Barnard, J. Chem. Inf. Comput. Sci., 1991, (31), 64-68
25. A Comparison of the MARPAT and Markush DARC Software, by N. R. Schmuff, J. Chem. Inf. Comput. Sci., 1991, (31), 53-59
26. The Sheffield generic structures project—a retrospective review, by M. F. Lynch, and J. D. Holliday, J. Chem. Inf. Comput. Sci., 1996, (36), 930-936
27. Computer Storage and Retrieval of Generic Chemical Structures in Patents. 17. Evaluation of the Refined Search, by J. D. Holliday, and M. F. Lynch, J. Chem. Inf. Comput. Sci., 1995, (35), 659-662.
28. Automatic translation of GENSAL representations of Markush structures into GREMAS fragment codes at IDC, by G. Stiegler, B. Maier, H. Lenz in Proceedings of the 2^{nd} International Conference on Chemical Information Systems, Noordwijkerhout, The Netherlands, June 1990, Warr, W. A. Ed, Springer Heidelberg.
29. Computer Storage and Retrieval of Generic Chemical Structures in Patents. 7. Parallel Simulation of a Relaxation Algorithm for the Chemical Substructure Search, by V J. Gillet, S. M. Welford, M. F. Lynch, P. Willett, J. M. Barnard, G. M. Downs, G. Manson, and J. Thomson, J. Chem. Inf. Comput. Sci., 1986, (26), 118-126
30. Computer Storage and Retrieval of Generic Chemical Structures in Patents. 8. Reduced Chemical Graphs, and their Application in Generic Chemical Structure Retrieval, by V. J. Gillet, G. M. Downs, A. B. Ling, M. F. Lynch, P. Venkataram, J. V. Wood, and W. Dethlefsen, J. Chem. Inf. Comput. Sci., 1987, (27), 126-137
31. Computer Storage and Retrieval of Generic Chemical Structures in Patents. 9. An Algorithm to Find the Extended Set of Smallest Rings (ESSR) in structurally explicit generics, by G. M. Downs, V. J. Gillet, J. D. Holliday, and M. F. Lynch, J. Chem. Inf. Comput. Sci., 1989, (29), 215-224
32. Computer Storage and Retrieval of Generic Chemical Structures in Patents. 10. The Assignment and Logical Bubble-up of Ring Screens for Structurally Explicit Generics, by G. M. Downs, V. J. Gillet, J. D. Holliday, and M. F. Lynch, J. Chem. Inf. Comput. Sci., 1989, (29), 215-224
33. Generic Chemical Structures in Patents (Markush Structures): the Research Project at the University of Sheffield, by M. F. Lynch, World Patent Inf., 1986, (8), 85-91
34. U.S. Pat. No. 4,642,762
35. Computer Storage and Retrieval of Generic Chemical Structures in Patents. 14. Fragment generation from Generic Structures, by J. D. Holliday, G. M. Downs, V. J. Gillet, M. F. Lynch, J. Chem. Inf. Comput. Sci., 1992, (32), 453-462
36. Computer Storage and Retrieval of Generic Chemical Structures in Patents. 15. Generation of Topological Fragment Descriptors from Nontopological Representation of Generic Structure Components, by J. D. Holliday, G. M. Downs, V. J. Gillet, M. F. Lynch, J. Chem. Inf. Comput. Sci., 1993, (33), 369-377
37. Computer Representation of Generic Chemical Structures by an Extended Block-Cutpoint Tree, by T. Nakayama, and Y. Fujiwara, J. Chem. Inf. Comput. Sci, 1983, (23), 80-87.
38. Computer Representation and handling of Structures: Retrospect and Prospects, by E. Meyer, J. Chem. Inf. Comput. Sci., 1991, (31), 69
39. E. Meyer, P. Schilling, and E. Sens, in Barnard, J. M. (Ed.) Computer Handling of Generic Chemical Structures, Gower, Aldershot, 1984, pp 83-95
40. Computer Representation and Manipulation of Combinatorial Libraries, by J. M. Barnard, and G. M. Downs, Perspective in Drug Discovery and Design, 1997, (7/8) 13-30
41. Derwent Chemical Indexing Listserver Discussion List (CHEMIND-L), http://www.derwent.co.uk/-internet/chem.html, November 1994
42. Use of Markush Structure Techniques to Avoid Enumeration in Diversity Analysis of Large Combinatorial Libraries, by J. M. Barnard, and G. M. Downs, MSI Combinatorial Chemistry Consortium Meeting, Feb. 11, 1997
43. http://www.daylight.com/release/f_manuals.html, section 5.9
44. Chemical Design Ltd., Chipping Norton, Oxon, U K, http://www.awod.com/-netsci/Companies/CDL
45. Online Chem-X documentation, at http://www-fbsc.ncicrf.gov/compenv/app_soft/man/chemx/document/refdbs/chap37.htm
46. Scalable methods for the Construction and Analysis of Virtual Combinatorial Libraries, V. S. Lobanov, and D. K. Agrafiotis, Combinatorial Chemistry & High Throughput Screening, 2002, (5), 167-178
47. ACS National Meeting, Chicago Ill., 26 Aug. 2001
48. U.S. Pat. Nos. 5,880,972, 6,061,636, and 6,377,895.
49. U.S. Pat. No. 6,253,618
50. G. M. Downs, and J. M. Barnard, J. Chem. Inf. Comput. Sci., 1997, (37), 59
51. Use of Markush Structure-Analysis Technique for Rapid Processing of Large Combinatorial Libraries, by J. M. Barnard, G. M. Downs, and R. D. Brown (CNIF, 5)
52. Techniques for Generating Descriptive Fingerprints in Combinatorial Libraries, by G. M. Downs, and J. M. Barnard, J. Chem. Inf. Comput. Sci., 1997, (37), 59-61
53. Use of Markush structure analysis techniques for descriptor generation and clustering of large combinatorial libraries, by J. M. Barnard, G. M. Downs, A. von Scholley-Pfab, and R. D. Brown, J. Molecular Graphics and Modelling, 2000, (18), 452-463
54. Molecular Simulations Inc., San Diego, Calif., USA, http://www.msi.com
55. The Effectiveness of Monomer Pools for Generating Structurally-Diverse Combinatorial Libraries, Poster presented by V. J. Gillett, P. Willett, and J. Bradshaw in the Knowledge-Based Library Design (KBLD) session of the First Electronic Molecular Graphics and Modeling Society Conference, Oct. 7-18, 1996
56. Efficient combinatorial filtering for desired molecular properties of reaction products, by S. Shi, Z. Peng, J. Kostrowicki, G. Paderes, and A Kuki, J. Mol. Graph. and Mod., 2000, (18), 478-496
57. A Fast Algorithm for Searching for Molecules Containing a Pharmacophore in Very Large Virtual Combinatorial Libraries, by R. Olender, and R. Rosenfeld, J. Chem. Inf. Comput. Sci., 2001, (41), 731-738
58. U.S. Pat. Nos. 6,185,506, and 6,240,374.

1. A method of operating a computer to identify all chemical structures defined by a Markush type formula (200,220,260), which is stored in a database matching a given query structure (200), without the necessity of generating said chemical structures, comprising the steps of:
(i) Processing said Markush type formula (e) and said query(ies) into a computer readable form (210),
(ii) Searching for partially relaxed subgraph isomorphism(s) for each said query (230, 240, 250), and
(iii) Retrieving data (270).

2. The method of claim 1, wherein said database is made of at least one combinatorial library stored as a Markush type formula (200).

3. The method of claim 2, wherein said libraries are each made of one scaffold and at least one R-group as constituents.

4. The method of claim 1, wherein said given query structure is either an exact chemical structure or a chemical substructure.

5. The method of claim 1, wherein said given query structure is said to match said chemical structure if said given query structure is exactly said chemical structure.

6. The method of claim 1, wherein said given query structure is said to match said chemical structure if said given query structure is either said chemical structure or either a substructure of said chemical structure.

7. The method of claim 1, wherein said identification can be performed with said query structure as sole input (200), without the requirement of additional information to perform said identification.

8. The method of claim 1, wherein said generation of chemical structures is neither required before nor during the search.

9. The method of claim 1, wherein said processing of said step (i) can either be performed before or either during said identification.

10. The method of claim 1, wherein said Markush type formula (e) can either be pre-processed (210) or processed during said identification.

11. The method of claim 1, wherein said query(ies) is(are) stored or not in a database.

12. The method of claim 3, wherein said processing of said step (i) comprises the steps of:
(a) Building of graphs and binary description of said scaffolds and R-groups, and
(b) Building of graph and binary description of said query(ies).

13. The method of claim 12, wherein said binary description of said step (a) contains or consists of the following information:
1. For each scaffold:
(a) Number of atoms present in said scaffold,
(b) Graph of said scaffold,
(c) Number of R-groups,
(d) Label of said R-groups,
(e) Position of said R-groups in said graph,
(f) Number of neighbours for each R-group and position of said neighbours in said graph, and
2. For each R-group:
(a) R-group identification (ID),
(b) Number of atoms present in said R-group,
(c) Graph of said R-group,
(d) Number of attachment points in said R-group,
(e) Attachment points identification (atoms indexing),
(f) Atoms involved in said attachment points.

14. The method of claim 3, wherein said partially relaxed subgraph isomorphism searching of said step (ii) of said claim 1 (240) is performed on all said libraries and comprises the steps of:
(a) Scaffold reading (300),
(b) Partially relaxed subgraph isomorphism searching of said query against said scaffold (310), and
(c) Processing of all isomorphisms (320 to 390), for each library of said database (220, 260).

15. The method of claim 14, wherein said processing of said step (c) comprises the step of:
(1) Counting the number of atoms of said query associated with each constituent of said library (330),
(2) Identifying which atoms of said query are associated with said constituent(s) (330),
(3) Identifying on which constituent(s) said query is located (330),ad
(4) Processing of said isomorphism taking into account said query location of said step
(3) (340 to 380),
for each isomorphism detected.

16. The method of claim 15, wherein said step (3) defines the global localisation of said query on said library constituent(s) as being either only the scaffold (340), or either only one single R-group (350) or either the scaffold and at least one R-group (350).

17. The method of claim 15, wherein said processing of said step (4) comprises the steps of:
(i) Processing of said isomorphism if said query is only located on the scaffold of said library (370),
(ii) Processing of said isomorphism if said query is only located on a single R-group of said library (380), and
(iii) Processing of said isomorphism if said query is located on the scaffold and at least one R-group of said library (360=all other cases).

18. The method of claim 17, wherein said processing of said step (i) (370) comprises the step of storing said chemical structures of claim 1 matching the query as a sub-library identical to said library (400).

19. The method of claim 17, wherein said processing of said step (ii) (380) comprises the steps of:
(a) Identifying members of said single R-group containing said query (500, 510, 530, 700 to 730), and
(b) Flagging said members (520).

20. The method of claim 19, wherein said chemical structures of claim 1 matching the query are stored as a sub-library corresponding to a Markush type formula made of said scaffold of claim 14, all members of R-groups not associated to said query and said flagged members of said single R-group identified by said query in said step (a) of claim 19 (550), if said single R-group has at least one member flagged (540).

21. The method of claim 17, wherein said processing of said step (iii) (360) comprises the steps of:
(a) Identifying if atoms of said query are associated with an R-group (610),
(b) Isomorphism searching (640, 700 to 730) of the sub-query (620) formed by said atoms, on each member (630, 660) of said associated R-group, if at least one atom is associated to said R-group (610), and
(c) Flagging each member of said associated R-group for which at least one isomorphism is detected (650),
for each R-group of said library (600, 670).

22. The method of claim 21, wherein all members of an R-group of said library are flagged if said R-group is not involved in said isomorphism of step (b) of claim 14.

23. The method of claim 21, wherein said chemical structures of claim 1 matching the query are stored as a sub-library corresponding to a Markush type formula made of said scaffold of claim 14, all members of R-groups not associated to said query and said flagged members of said associated R-groups (690), if all said associated R-groups have at least one member flagged (680).

24. The method of claim 23, wherein said flagged members that match said sub-query are kept in a list for said isomorphism searching as IDs pointing to graphs.

25. The method of claim 21, wherein the association of atoms in said query with atoms in said scaffold is saved, defining the partial localisation of said query on the sub-library.

26. The method of claim 21, wherein a same list of members is used for different R-groups of said library sharing the same members.

27. The method of claim 21, wherein said sub-query isomorphism searching of said step (b) comprises the steps of:
(1) Building said sub-query to be searched in said associated R-group (620),
(2) Determining attachment point's constraints (620), and
(3) Isomorphism searching (640, 700 to 730) with said attachment points' constraints for each said associated R-group's member (630, 660).

28. The method of claim 27, wherein graph connectivity of said sub-query is checked in step (1), meaning that atoms associated to a given R-group make a connected graph.

29. The method of claim 27, wherein said isomorphism searching of said step (3) is partially relaxed or not (720 or 710).

30. The method of claim 27, wherein said determining of attachment points' constraints of said step (2) is defined as follows:
(i) For each neighbour C[i] of order i of said R-group in said scaffold, if said neighbour is associated to an atom of said query then D[i] represents said atom in said query, otherwise D[i]=Ø,
(ii) For each said order i, if D[i] is defined then for each of the neighbour of D[i] in said query, if said neighbour is mapped to said R-group, A[i] represents said neighbour, otherwise A[i] is not defined (A[i]=Ø), and
(iii) The array A represents the constraints of said attachment points.

31. The method of claim 27, wherein said isomorphism searching of said step (3) comprises the steps of:
(a) Reading said member (630), and
(b) Searching of all the isomorphisms of said sub-query (640, 700 to 730) on said member with said constraints on attachment points: said atom A[i] of said sub-query must be mapped to the attachment point of order i of said member, for each i where A[i] is defined.

32. The method of claim 31, wherein the number of isomorphisms is counted in said step (b).

33. The method of Rep claim 31, wherein only the first isomorphism is searched in said step (b).

34. The method of claim 31, wherein said method further comprises the step of saving all the isomorphism's descriptions, which defines, along with said partial localisation, the exact localisation of said query on said library.

35. The method of claim 31, wherein said searching of said isomorphisms (640, 700 to 730) of said step (b) comprises the additional steps of:
(i) Analysing each said member for the presence of a nested R-group (700), and
(ii) Proceeding recursively to claim 14 (720=240) with said query of said claim 14 corresponding now to said sub-query, said scaffold of said claim 14 corresponding now to said R-group and said R-groups are the said nested ones, until said nested R-groups are no more involved in an isomorphism, if said member contains a nested R-group (700).

36. The method of claim 3, wherein said data retrieval of said step (iii) retrieves at least one of the following information:
For the entire said database:
Said database contains or does not contain said query or is there at least one said library that contains said query,
A list of all the combinatorial libraries containing said query,
A list of all the combinatorial libraries not containing said query,
A list and number of said scaffolds containing entirely said query,
A list and number of said scaffolds not containing entirely said query,
A list and number of said R-groups containing entirely said query whether nested R-groups are allowed or not,
A list and number of said R-groups not containing entirely said query whether nested R-groups are allowed or not,
The total number of isomorphisms retrieved in step (b) of claim 14 (310) for all the libraries, whether said associated R-groups of claim 15 have at least one member flagged during said processing of said step (4) or not (540, 680),
The global or partial localisation for all the isomorphisms,
The first isomorphism found with or without its global or partial localisations,
For each said library:
Said library contains or does not contain said query,
A list and number of all the enumerated (specific) structures or non-enumerated structures of said library matching said query,
The number of unique structures of said library matching said query, whatever the number of partial localisations of said query on said library,
The number of times said query is located on said scaffold only, or on said R-groups only, or spans across said scaffold and said R-group(s). This corresponds to the number of global localisations,
The total number of isomorphisms retrieved in step (b) of claim 14, whether said associated R-groups of claim 15 have at least one member flagged during said processing of step (4) or not. This corresponds to the total of the number of said partial localisations of said query on said library,
A list of all said partial localisations of said query on said library, each one corresponding to an isomorphism and defining a sub-library,
For each said R-group:
Said R-group contains or does not contain said query or said sub-query,
A list and number of all the specific members or non-enumerated members of said R-group containing said query or said sub-query, whether nested R-groups are allowed or not,
A list and number of all the specific members or non-enumerated members of said R-group not containing said query or said sub-query, whether nested R-groups are allowed or not,
The number of times said query or sub-query is found in said R-group's members whether exact localisation or nested R-groups are taken into account or not. This corresponds to the total number of isomorphisms for all said R-group's members,
For each said member of said R-group:
Said member contains or does not contain said query or said sub-query,
The number of times said query or sub-query is found on said member whether nested R-groups are taken into account or not. This corresponds to the number of isomorphisms of said sub-query on said member,
A list and number of all the specific structures or non-enumerated structures described by said member containing said query or said sub-query if said member contain nested R-group(s),
The exact localisation of said query or sub-query on said member,
For each single isomorphism of said query or sub-query:
The library corresponding to said isomorphism,
A list and number of R-groups associated to at least one atom of said query in said isomorphism,
A list and number of R-groups not associated to any of the atoms of said query in said isomorphism,
A list and number of members containing said query or said sub-query for each said R-group,
A list and number of members not containing said query or said sub-query for each said R-group,
The global localisation of said query on said library, i.e. said query is either only on the scaffold, or either only on one R-group or either on the scaffold and at least one R-group,
The partial localisation of said query on said library, i.e. the atoms in the scaffold and the R-group(s) to which atoms in the query are mapped,
A list of all the specific structures or non-enumerated structures containing said query and mapping on said library following said partial localisation, and
For all the isomorphisms of said query or sub-query:
All the information gathered in the aforementioned points.

37. The method of claim 1, wherein said data retrieval of said step (iii) retrieves said structures in the form of either enumerated or either non-enumerated structures.

38. The method of claim 1, wherein said data retrieval of said step (iii) takes into accounts nested R-groups.

39. The method of claim 1, wherein said data retrieval of said step (iii) takes into account the exact localisation of said query for each said isomorphism.

40. The method of claim 1 further comprising the application of screening technique(s) option(s) to reduce search time.

41. The method of claim 40, wherein said screening technique option relies on substructural features.

42. The method of claim 1, wherein it can be integrated in a pipeline.

43-48. (canceled)

49. A drug compound obtained by synthesising a molecule determined by performing the method according to claim 1.

50. A computer program for the automatic identification of all the chemical structures defined by a Markush type formula (e), which is stored in a database matching a given query structure, without the necessity of generating said chemical structures, comprising computer code means adapted to perform the method of claim 1 when said program is run on a computer; or
computer readable medium having a program recorded thereon, said program comprising a computer program for the automatic identification of all the chemical structures defined by a Markush type formula (e), which is stored in a database matching a given query structure, without the necessity of generating said chemical structures, comprising computer code means adapted to perform the method of claim 1 when said program is run on a computer;
a computer loadable product directly that is loadable into the internal memory of a digital computer, said product comprising software code portions the automatic identification of all the chemical structures defined by a Markush type formula (e), which is stored in a database matching a given query structure, without the necessity of generating said chemical structures, adapted to perform the method of claim 1 when said product is run on a computer; or
an apparatus for performing the method of claim 1, said apparatus comprising data input means for inserting said at least one given query structure.
